(19) United States
(12) Patent Application Publication
(10) Pub. No.: US 2013/0250428 A1
(43) Pub. Date: Sep. 26, 2013

(54) MAGNIFYING IMAGING OPTICAL UNIT AND METROLOGY SYSTEM COMPRISING SUCH AN IMAGING OPTICAL UNIT

(71) Applicant: Carl Zeiss SMT GmbH, Oberkochen (DE)

(72) Inventor: Hans-Juergen Mann, Oberkochen (DE)

(21) Appl. No.: 13/901,003

(22) Filed: May 23, 2013

Related U.S. Application Data
(63) Continuation of application No. PCT/EP2012/051379, filed on Jan. 27, 2012.
(60) Provisional application No. 61/437,286, filed on Jan. 28, 2011.

(30) Foreign Application Priority Data
Jan. 28, 2011 (DE) 102011003302.5

(51) Int. Cl. G02B 27/14

(52) U.S. Cl. CPC G02B 27/14
USPC 359/629

(57) ABSTRACT

A magnifying imaging optical unit (7) has at most four mirrors (M1 to M4), which, via an imaging beam path (8) having imaging partial rays (25, 19, 20) between the mirrors (M1 to M4) that are adjacent in the imaging beam path (8), image an object field (6) in an object plane (11) into an image field (9) in an image plane (12). The optical unit (7) is designed a first imaging partial ray (19) such that between a second mirror (M2) in the imaging beam path (8) and a third mirror (M3) in the imaging beam path (8) and a second imaging partial ray (20) between the third mirror (M3) in the imaging beam path (8) and a fourth mirror (M4) in the imaging beam path (8) respectively pass through at least one passage opening (21) in a mirror body (22) of a first mirror (M1) in the imaging beam path (8). According to a further aspect, the optical unit has a structural length T that is at most 1300 mm, and a ratio T/β of the structural length T and an imaging scale β that is less than 1.5. This results in an imaging optical unit that takes account of increased requirements made of the compactness and the transmission of the imaging optical unit, particularly for a given imaging scale.

The contents of German patent application DE 10 2011 003 302.5 are incorporated by reference.

The invention relates to a magnifying imaging optical unit, and to a metrology system comprising such an imaging optical unit.

A magnifying imaging optical unit of the type mentioned in the introduction is known for the simulation and analysis of effects of properties of masks for microlithography from DE 102 20 815 A1. Further imaging optical units are known from U.S. Pat. No. 6,894,834 B2, WO 2006/0069725 A1, U.S. Pat. No. 5,071,240, U.S. Pat. No. 7,623,620, US 2008/0175349 A1 and WO 2010/148293 A2.

It is an object of the present invention to develop an imaging optical unit of the type mentioned in the introduction in such a way as to take account of increased requirements made of the compactness and the transmission of the imaging optical unit, particularly for a given imaging scale.

The object is achieved according to a first aspect according to the invention by means of an imaging optical unit comprising the features specified in claim 1, and is achieved according to a further aspect according to the invention by means of an imaging optical unit comprising the features specified in claim 5.

It has been recognized according to the invention that when the two imaging partial rays between the second and third mirrors and between the third and fourth mirrors in the imaging beam path pass through the mirror body of the first mirror, compact designs of the imaging optical unit can be realised in which the last mirror in the imaging beam path can nevertheless occupy a position at a large distance from the image field.

In an alternative embodiment, only an imaging partial ray between a second mirror in the imaging beam path and a third mirror in the imaging beam path may pass through at least one passage opening in a mirror body of the first mirror in the imaging beam path. The passage opening may be a through-hole or may be an edge side recess in the first mirror M1.

Systems having a large image-side vertex focal length or a large image-side back focal distance and a correspondingly large imaging scale can thus be realised. The design comprising at most four mirrors ensures low reflection losses, particularly when the imaging optical unit is used with EUV radiation in the wavelength range of between 5 nm and 30 nm. The angle of incidence on the mirrors of the imaging optical unit can also be kept small, which is advantageous for the design of the mirrors with optimized reflectivity.

The second imaging partial ray may run between a third mirror and a fourth mirror in the imaging beam path.

The imaging optical unit may have exactly three mirrors. In that case, the second imaging partial ray may run between the third mirror in the imaging beam path and the image field. The imaging optical unit may be a catoptric optical device.

In so far as, according to claim 2, the first and second imaging partial rays pass through the same passage opening in the mirror body of the first mirror, the first mirror can be manufactured with relatively little outlay. Separate passage openings in the first mirror for the imaging partial rays that pass through the latter are also possible, which can lead to a low loss of reflection area on the first mirror on account of the passage openings and thus to low reflection losses at the first mirror.

Designing the optical unit according to claim 3 allows an even more compact design. Shading the passage opening in the mirror body of the first mirror according to claim 4 reduces or avoids an additional obscuration by the at least one passage opening. In so far as a plurality of passage openings are provided in the first mirror, the imaging optical unit can be designed such that at least one of the passage openings is shaded by one of the mirrors at least in sections in the imaging beam path.

A ratio T/β between the structural length T and the imaging scale β of the imaging optical unit according to the further aspect likewise ensures a compact embodiment of the imaging optical unit. The structural length can be 1439 mm, can be 1300 mm, can be 1227 mm, can be 1093 mm, can be 1010 mm, can be at most 1000 mm, can be 900 mm, can be 878 mm, can be at most 800 mm, can be 741 mm and can be 700 mm. The ratio T/β of the structural length and the imaging scale can be less than 1.6, can be 1.502, can be 1.44, can be less than 1.2, can be 1.17, can be less than 1.1, can be less than 1.0, can be 0.98, can be 0.94, can be less than 0.9 and can be 0.87. Other ratios T/β may be realized, depending on the respective embodiment. The imaging scale can be greater than 500, can be greater than 700, can be 711, can be 750, can be greater than 800 and can be 850. An object-side chief ray angle α of at least 6° enables a reflective object to be imaged without components of the imaging optical unit and components of an illumination optical unit disturbing one another. Alternatively, an object-side chief ray angle α between a normal to the object plane and a chief ray of a central object field point can be less than 1°. These alternative chief ray angles for the further aspect of the invention can be optimized for dark field illumination and/or bright field illumination. Depending on the chief ray angle, the examination of a reflective reticle or else of a transmissive reticle, for example of a phase shift mask, is possible.

An object-side numerical aperture according to claim 6 allows a large imaging scale. In addition, depending on the design of an illumination optical unit, for illuminating an object, this allows different illumination geometries, for example dark field or bright field illumination.

An object field according to claim 7 is suited to the surfaces to be examined particularly when checking lithography masks in projection exposure, particularly in EUV projection exposure. The object field can be rectangular. The object field can have a size of 100 μm×300 μm, 100 μm×400 μm or 100 μm×200 μm.

An RMS (root mean square) wavefront aberration according to claim 8 and/or a distortion according to claim 9 result in aberration correction that suffices for object examination particularly with a CCD array. The wavefront aberration (RMS) can be 465 mλ, can be at most 250 mλ, can be 216 mλ, can be at most 31 mλ, can be at most 30 mλ, at most 25 mλ, can be 22 mλ, can be at most 20 mλ, can be at most 10 mλ, can be 6 mλ and can even be just 2 mλ. The maximum distortion can be 63.8 μm, can be at most 50 μm, can be at most 25 μm, can be at most 15 μm, can be 12.3 μm, can be at most 1500 nm, can be 1000 nm, can be 500 nm, can be 400 nm, can be 300 nm, can be 150 nm and can even be just 40 nm.

Other object-side numerical apertures, other object field sizes and other RMS wavefront abberations may be realized, depending on the respective embodiment.

Chief ray angles in the alternatives according to claim 10 for the first aspect can be optimized for a dark field illumination and/or bright field illumination. Depending on the chief ray angle, the examination of a reflective reticle or else a transmissive reticle, for example of a phase shift mask, is possible.

Configurations of the imaging optical unit according to the alternative embodiments in claims 11 and 12 can be prescribed in a manner optimized in respect of structural space depending on the configuration of an illumination optical unit for illuminating the object field. These configurations of the imaging optical unit give rise to corresponding free spaces in which components of the illumination optical unit can be accommodated.

An aperture stop according to claim 13 defines the imaging beam path. The aperture stop can be configured in a manner capable of being decentred for variation of a chief ray angle. In addition, the aperture stop can be configured with an adaptable diameter for variation of the object-side numerical aperture. Three imaging partial rays, four imaging partial rays or even five imaging partial rays or partial beams can pass through the aperture.

At least two intermediate image planes according to claim 14 increase the degrees of freedom when designing the optical design. This can be used, in particular, in order that the imaging light partial ray between the last mirror and the image field at the level of the first mirror can also be configured compactly such that a passage opening in the first mirror can be provided for this imaging light partial ray as well. A configuration of the imaging optical unit with exactly one intermediate image or completely without an intermediate image is also possible.

The advantages of a metrology system according to claim 15 correspond to those which have already been explained above with reference to the imaging optical unit. A CCD sensor, in particular a TDI CCD sensor, can be provided as detection device.

The features of the imaging optical units explained above can also be present in combination with one another and may constitute independently relevant aspects of the invention not in detail referred to above.

Exemplary embodiments of the invention are explained in greater detail below with reference to the drawing, in which:

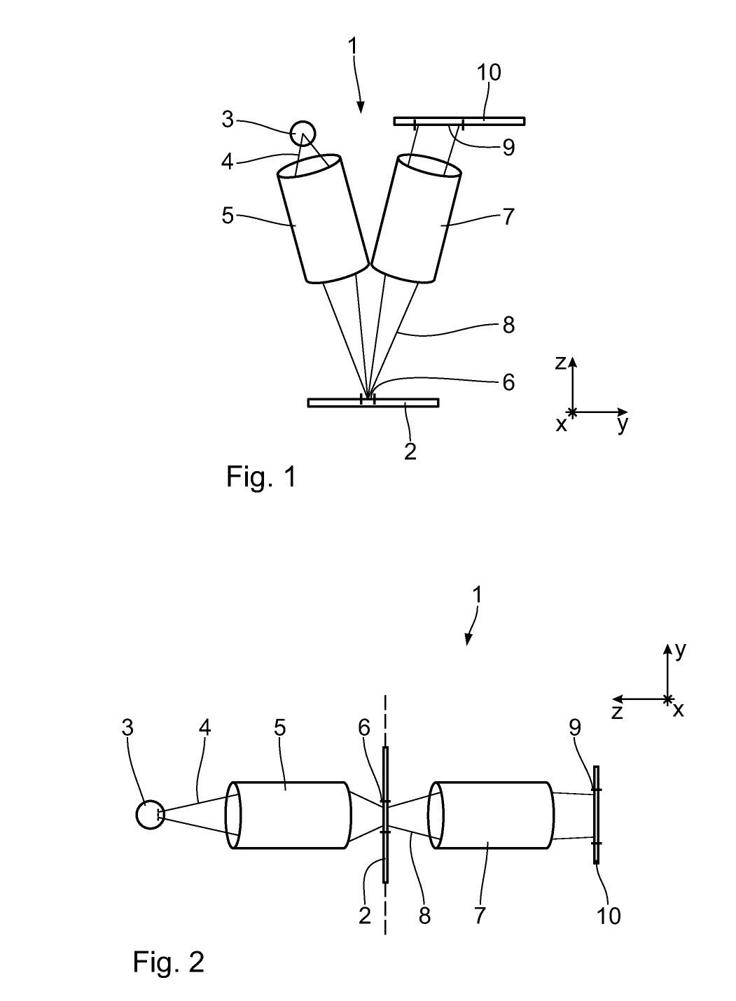

FIG. 1 schematically shows a metrology system for examining objects, wherein a reflective reticle for EUV projection lithography serves as an object to be examined;

FIG. 2 shows, in an illustration similar to FIG. 1, a further embodiment of a metrology system, wherein a transmissive reticle for EUV projection lithography, e.g. a phase shift mask, serves as an object to be examined;

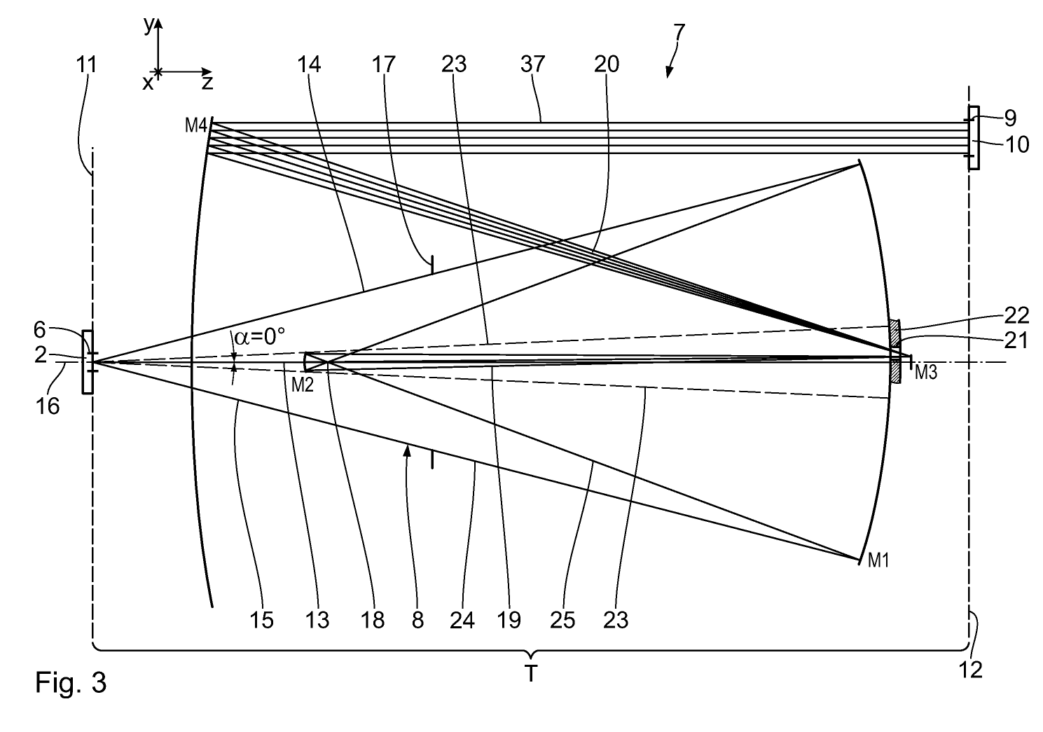

FIG. 3 shows a meridional section through an embodiment of a magnifying imaging optical unit for use in a metrology system according to FIG. 1 or 2, wherein the imaging optical unit serves for simulation and for analysis of effects and of properties of lithography masks, that is to say reticles, on optical imaging within a projection optical unit of a projection exposure apparatus for EUV projection lithography or else for the large-area detection of mask defects;

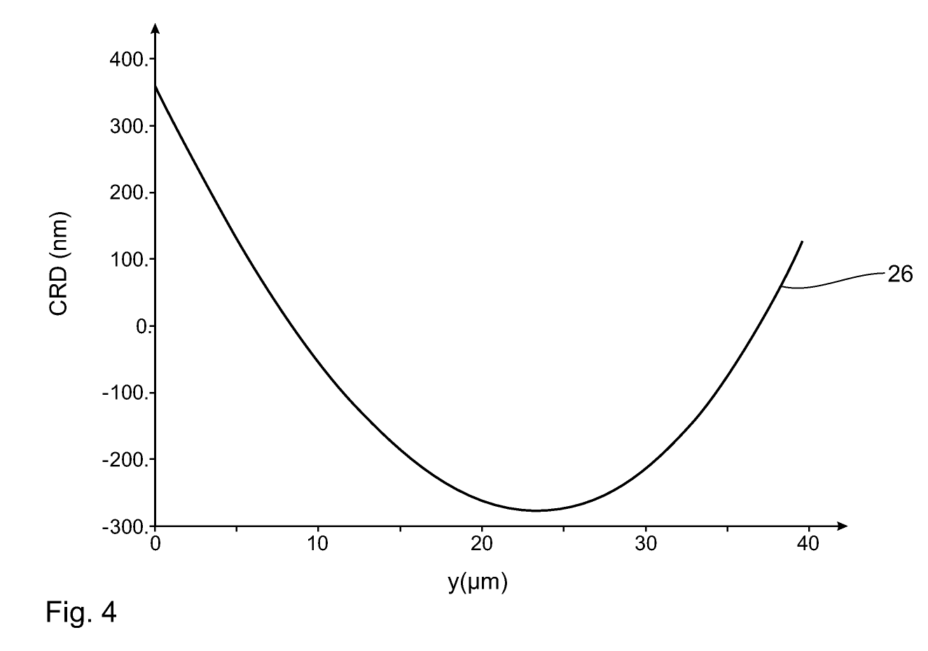

FIG. 4 shows, in a diagram, the dependence of a chief ray distortion CRD on a field height y of an object field of the imaging optical unit according to FIG. 3, wherein the field height y runs in a meridional plane that coincides with the plane of the drawing of FIG. 3 and perpendicularly to an optical axis of the imaging optical unit, wherein a scanning direction for moving a mask to be examined runs along the y-direction;

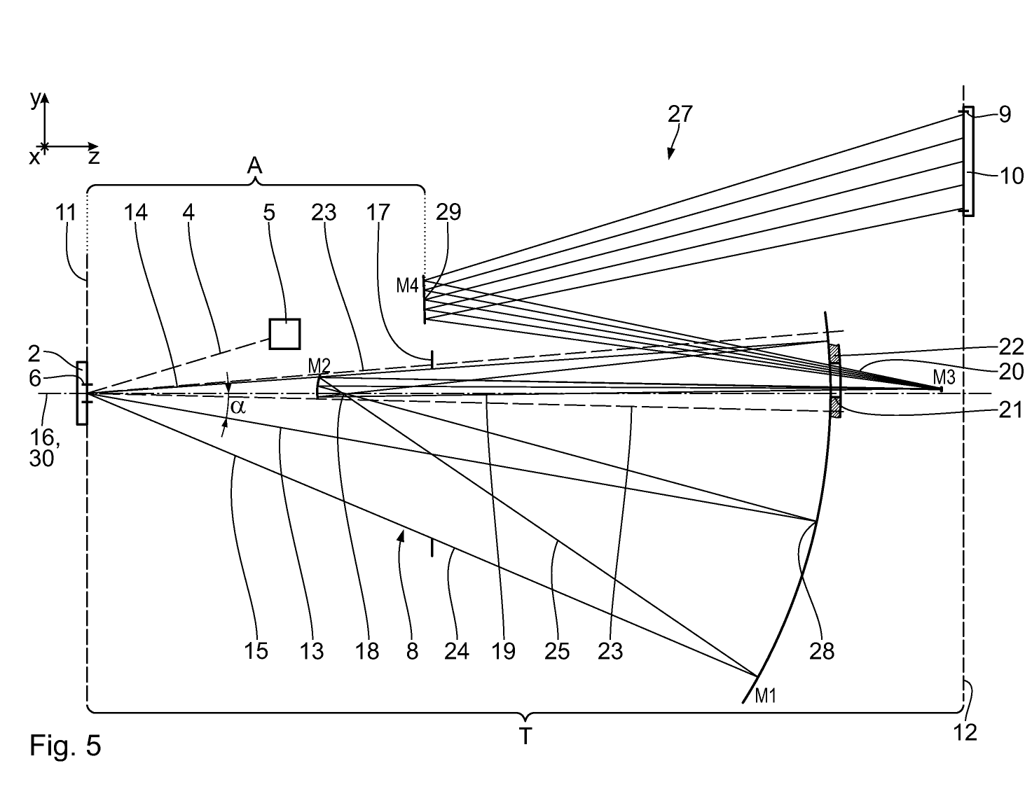

FIG. 5 shows, in an illustration similar to FIG. 3, a further embodiment of the imaging optical unit;

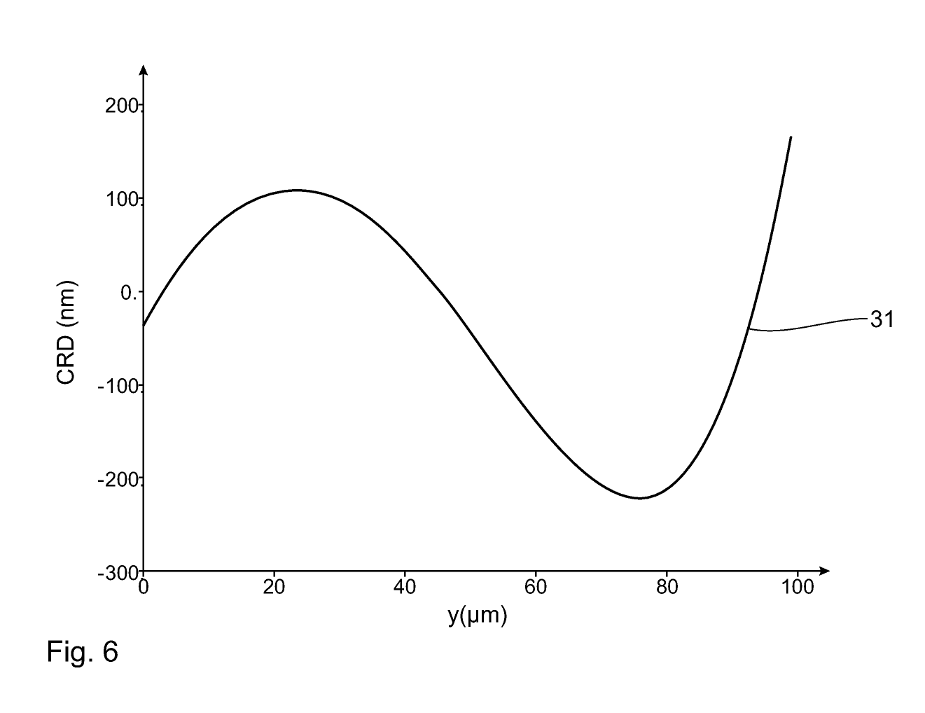

FIG. 6 shows, in an illustration similar to FIG. 4, the dependence of the chief ray distortion CRD against the field height y for the imaging optical unit according to FIG. 5;

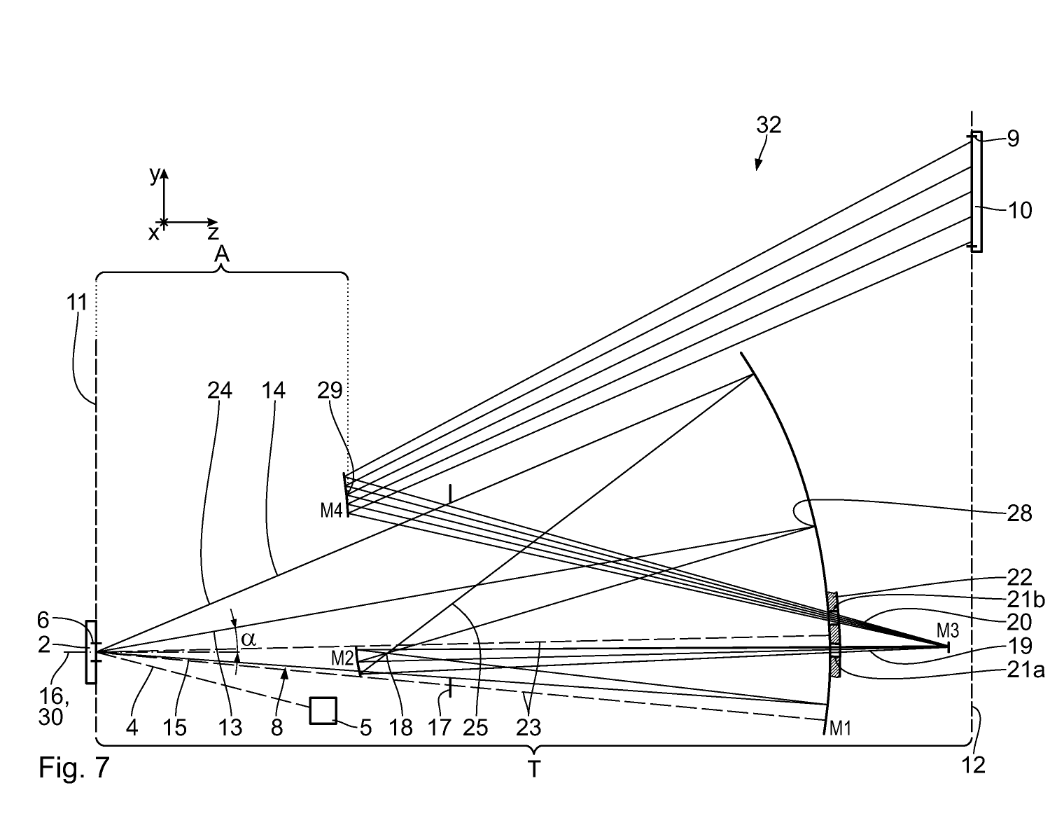

FIG. 7 shows, in an illustration similar to FIG. 3, a further embodiment of the imaging optical unit;

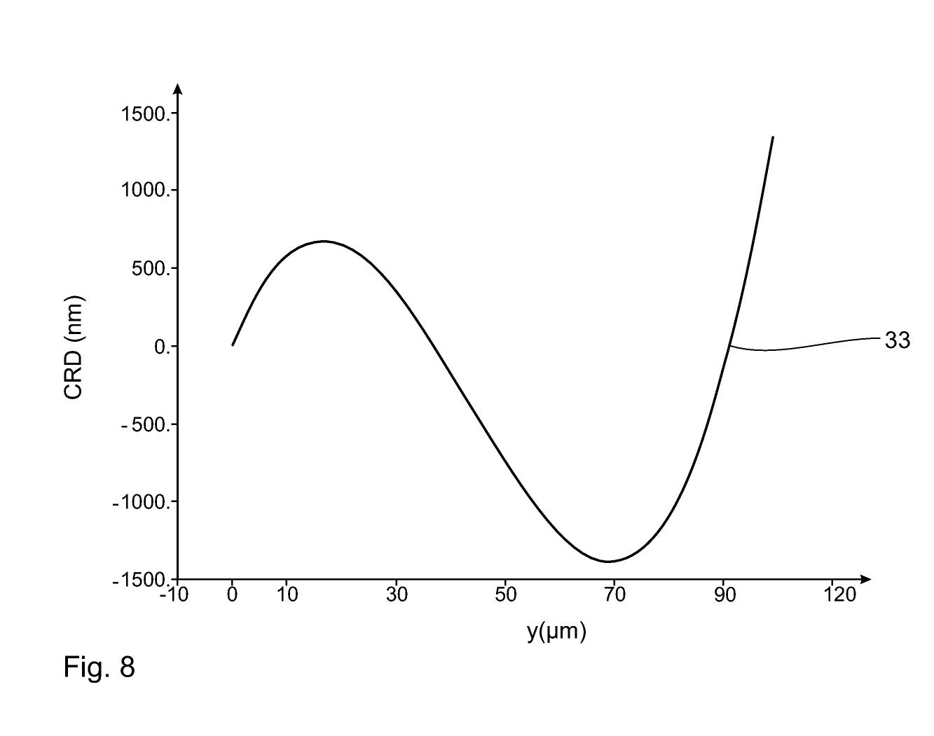

FIG. 8 shows, in an illustration similar to FIG. 4, the dependence of the chief ray distortion CRD against the field height y for the imaging optical unit according to FIG. 7;

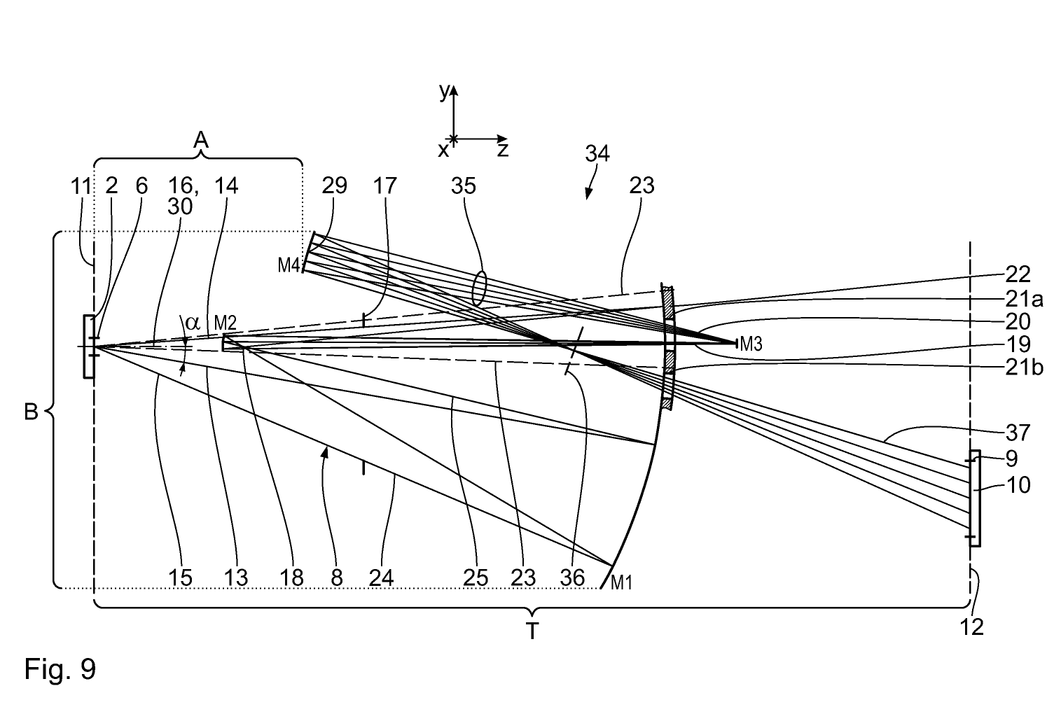

FIG. 9 shows, in an illustration similar to FIG. 3, a further embodiment of the imaging optical unit;

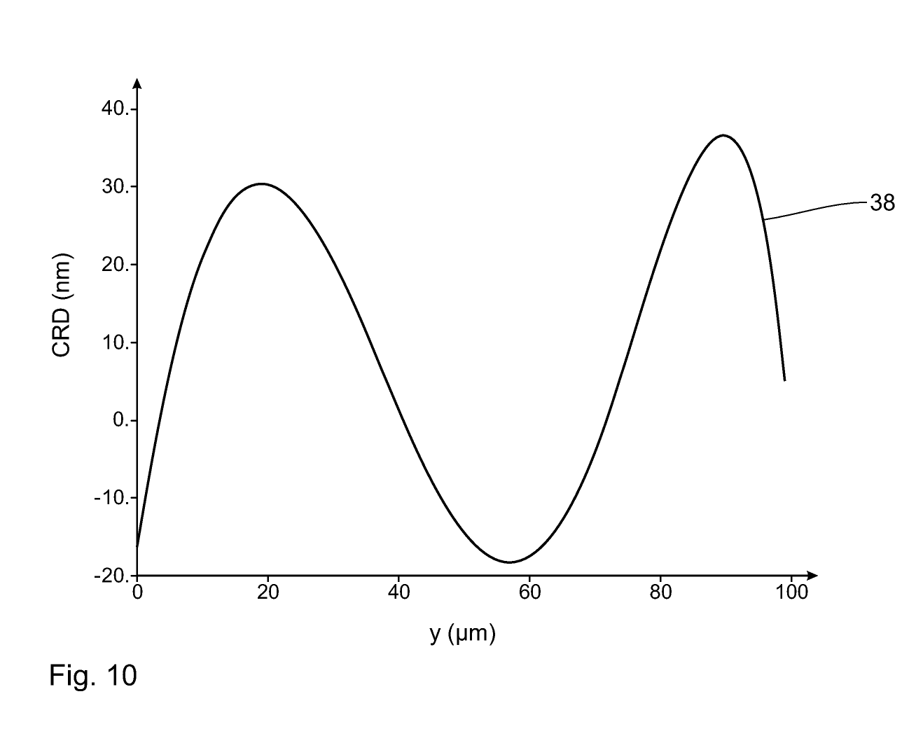

FIG. 10 shows, in an illustration similar to FIG. 4, the dependence of the chief ray distortion CRD against the field height y for the imaging optical unit according to FIG. 9;

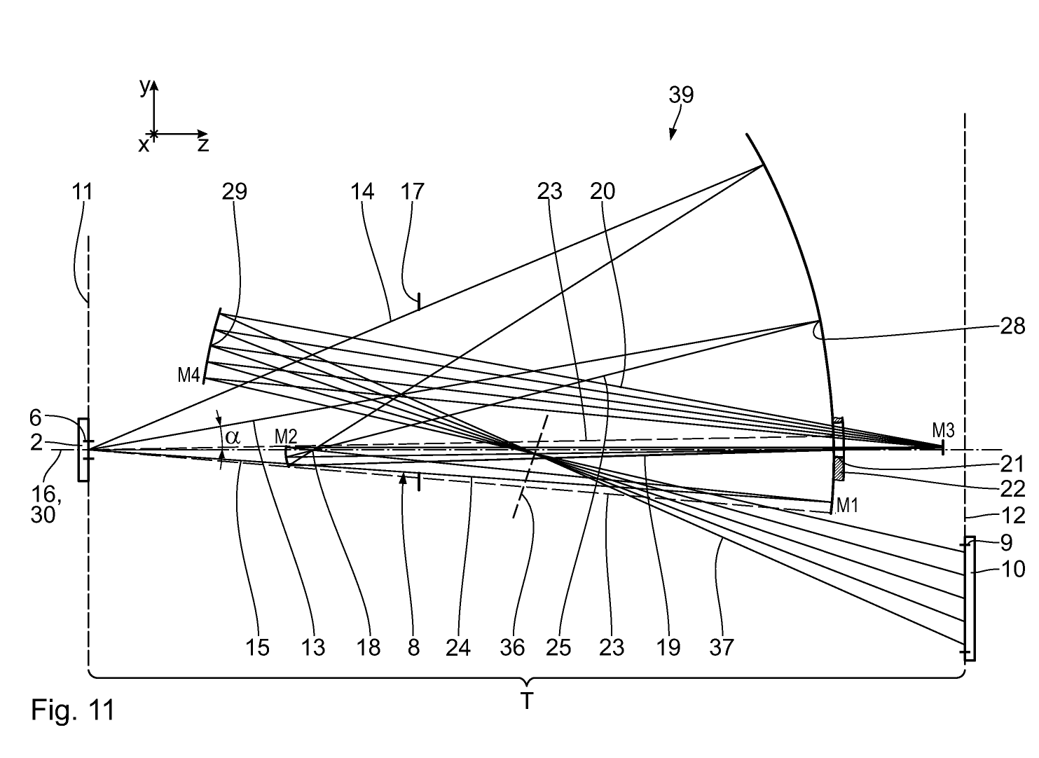

FIG. 11 shows, in an illustration similar to FIG. 3, a further embodiment of the imaging optical unit;

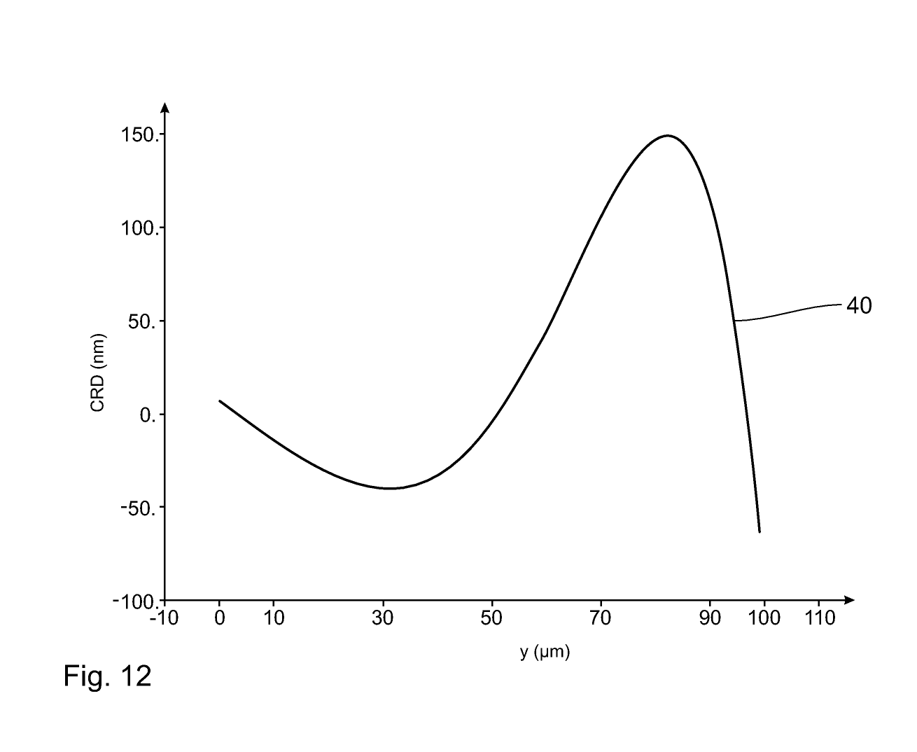

FIG. 12 shows, in an illustration similar to FIG. 4, the dependence of the chief ray distortion CRD against the field height y for the imaging optical unit according to FIG. 11;

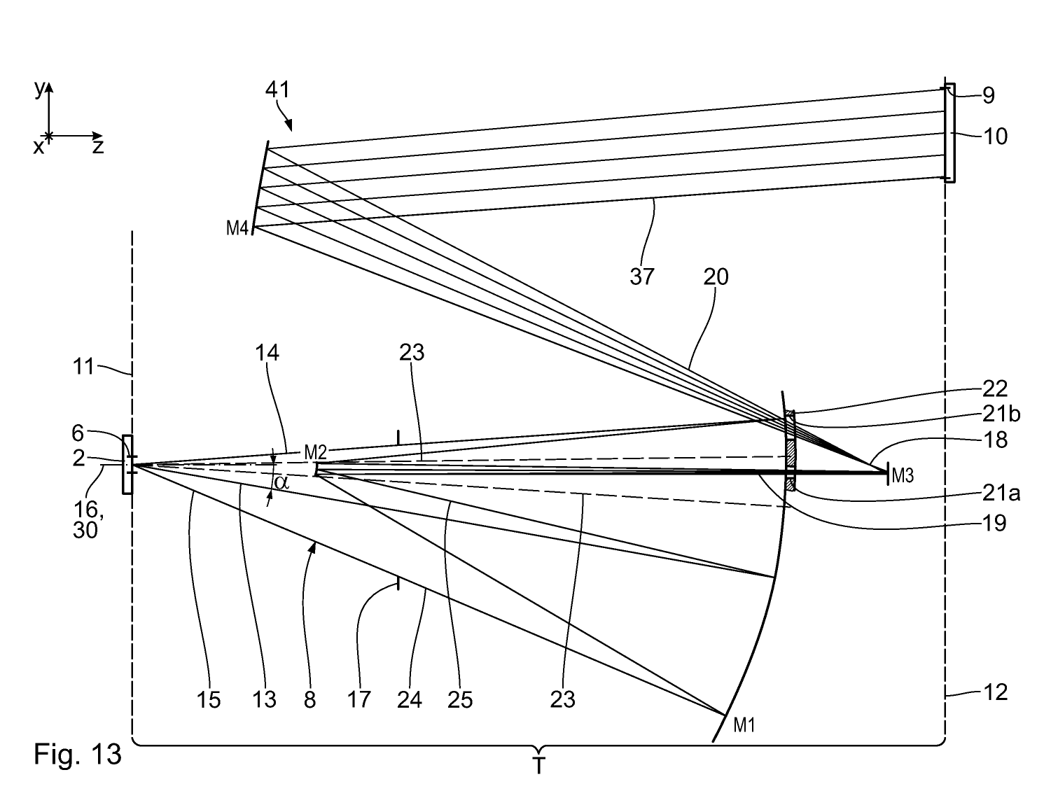

FIG. 13 shows, in an illustration similar to FIG. 3, a further embodiment of the imaging optical unit;

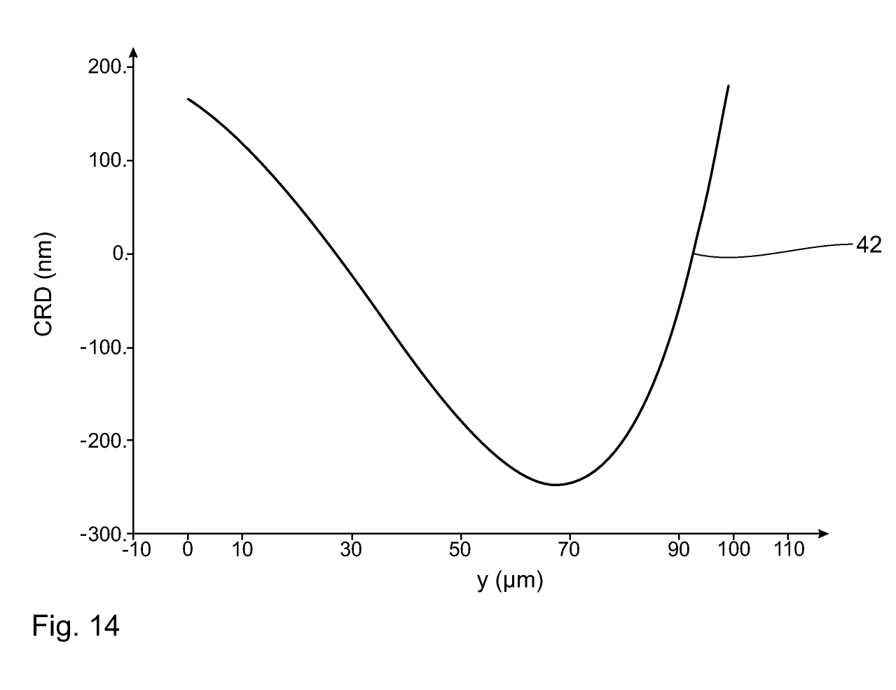

FIG. 14 shows, in an illustration similar to FIG. 4, the dependence of the chief ray distortion CRD against the field height y for the imaging optical unit according to FIG. 13;

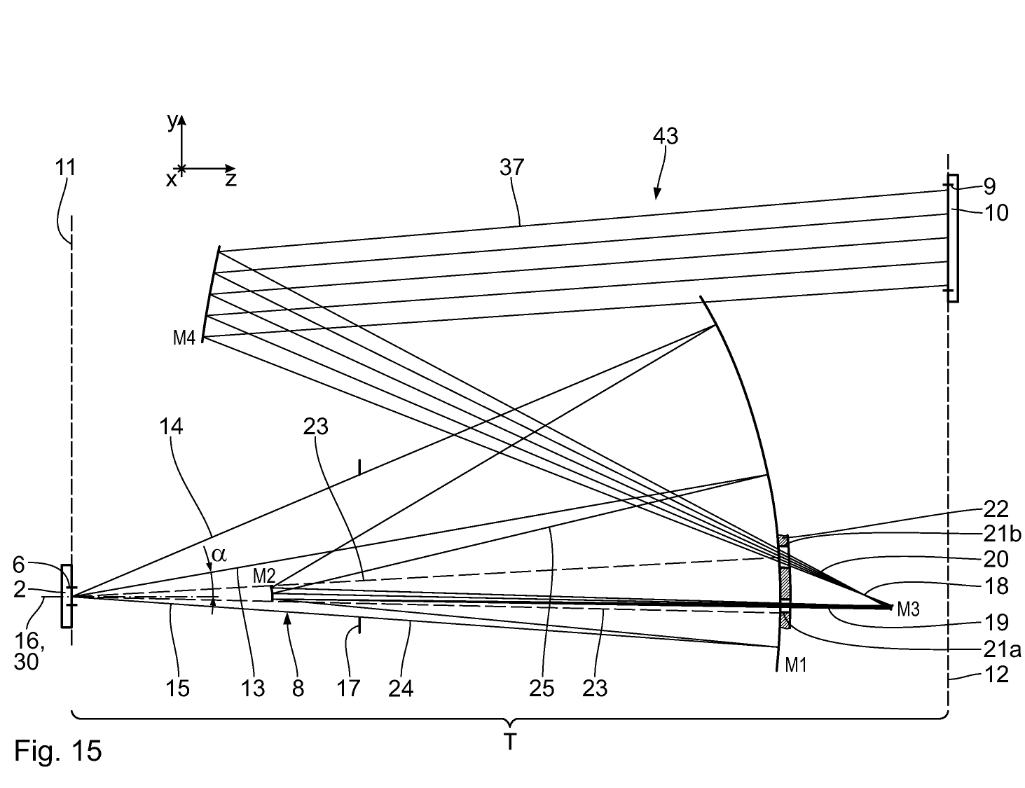

FIG. 15 shows, in an illustration similar to FIG. 3, a further embodiment of the imaging optical unit;

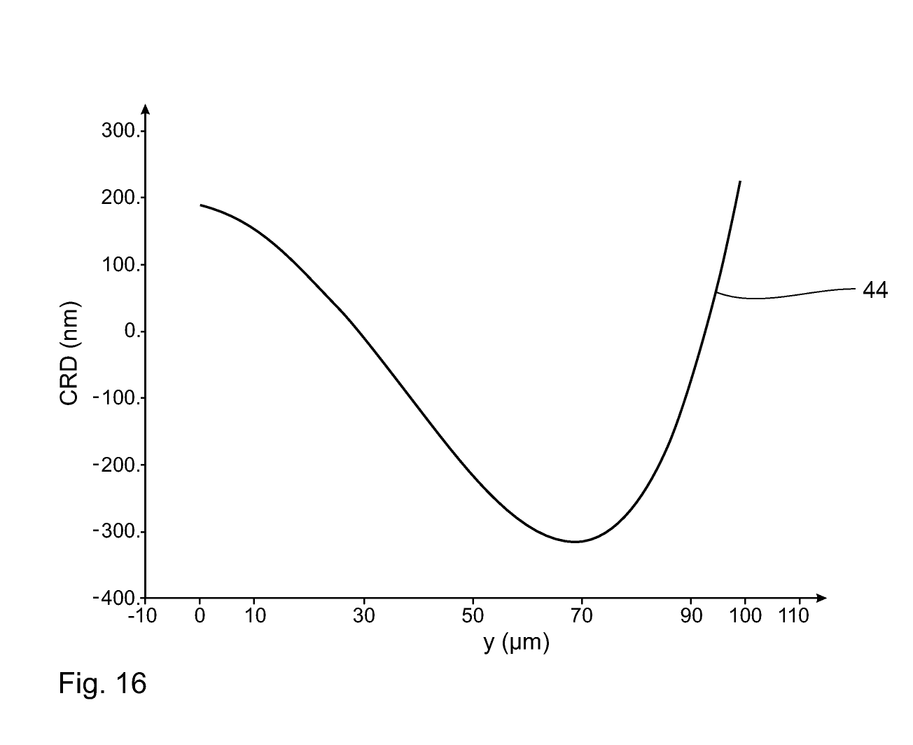

FIG. 16 shows, in an illustration similar to FIG. 4, the dependence of the chief ray distortion CRD against the field height y for the imaging optical unit according to FIG. 15;

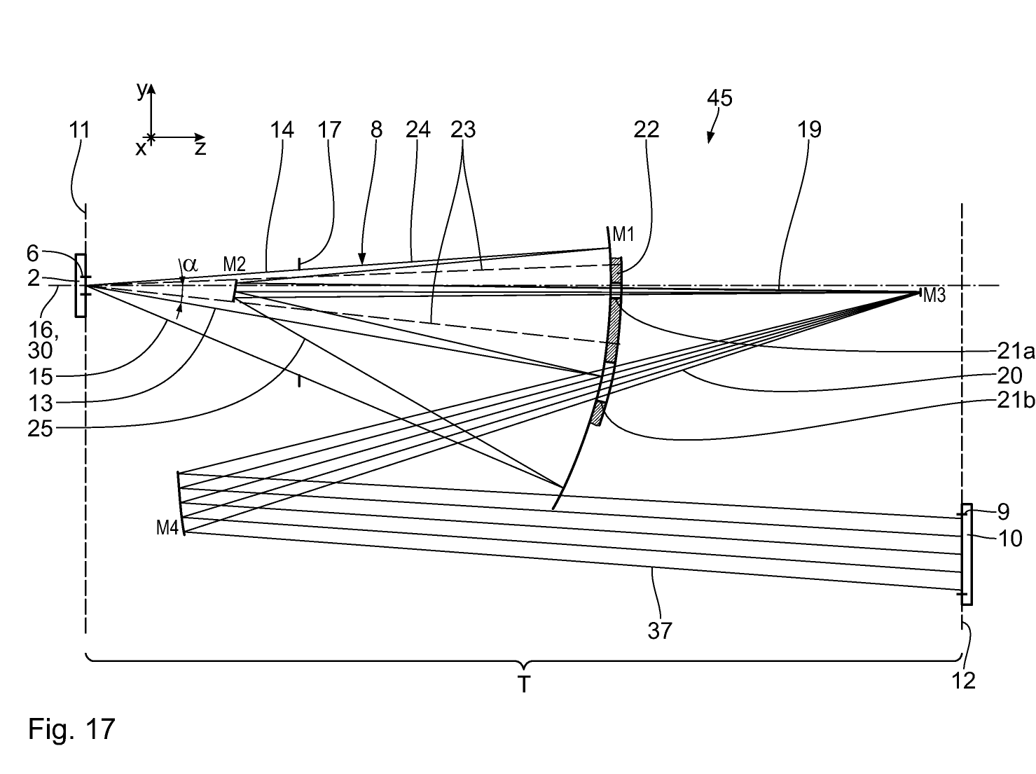

FIG. 17 shows, in an illustration similar to FIG. 3, a further embodiment of the imaging optical unit;

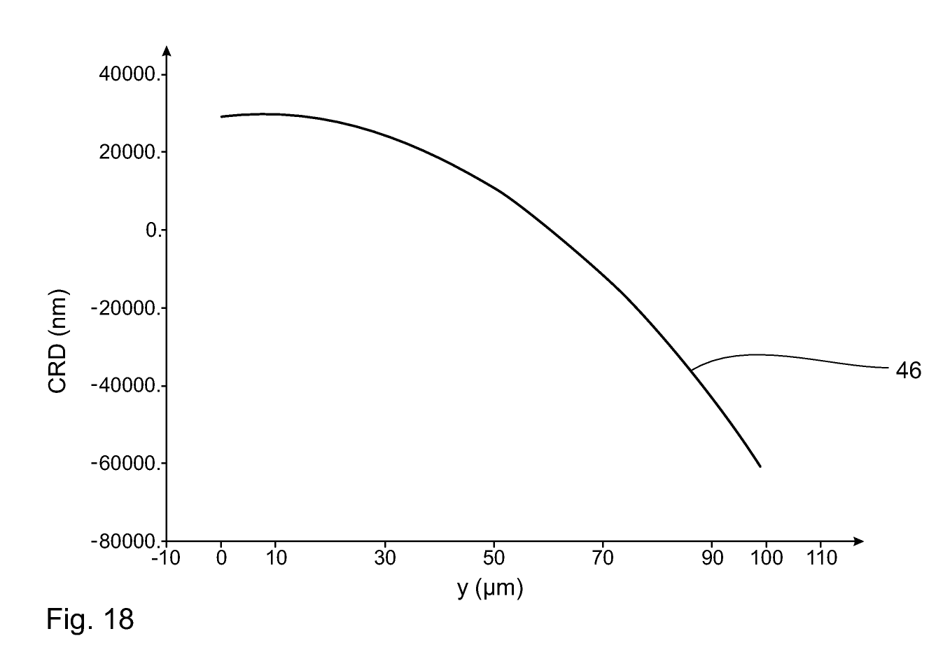

FIG. 18 shows, in an illustration similar to FIG. 4, the dependence of the chief ray distortion CRD against the field height y for the imaging optical unit according to FIG. 17;

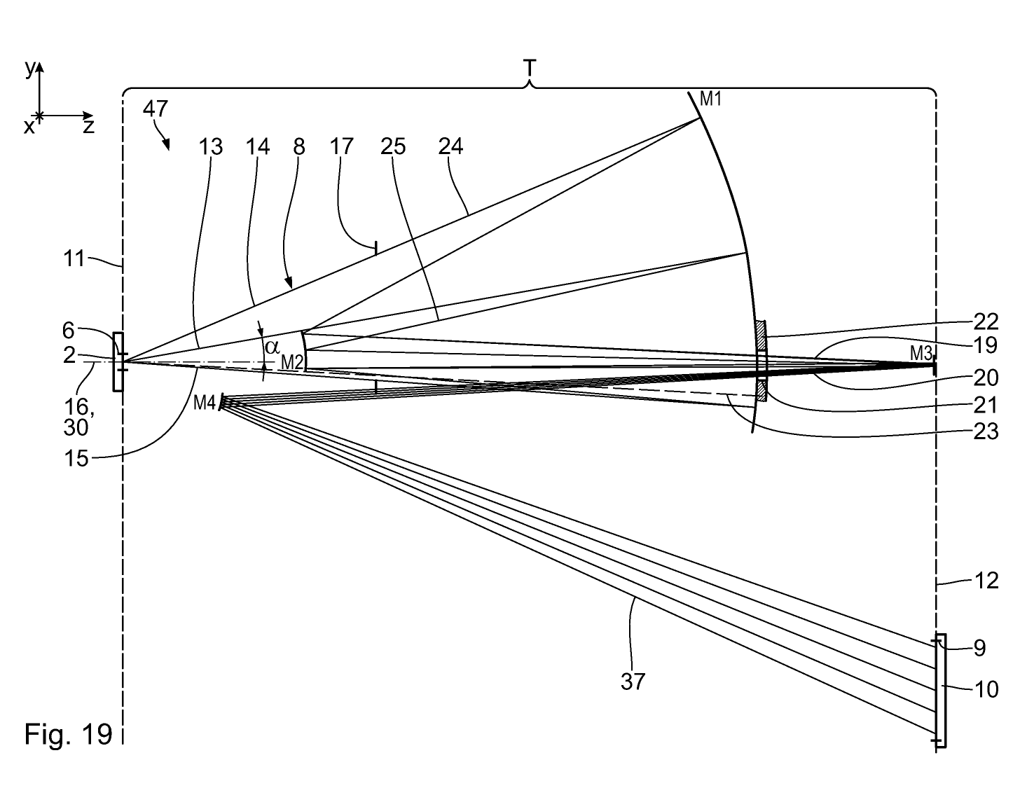

FIG. 19 shows, in an illustration similar to FIG. 3, a further embodiment of the imaging optical unit;

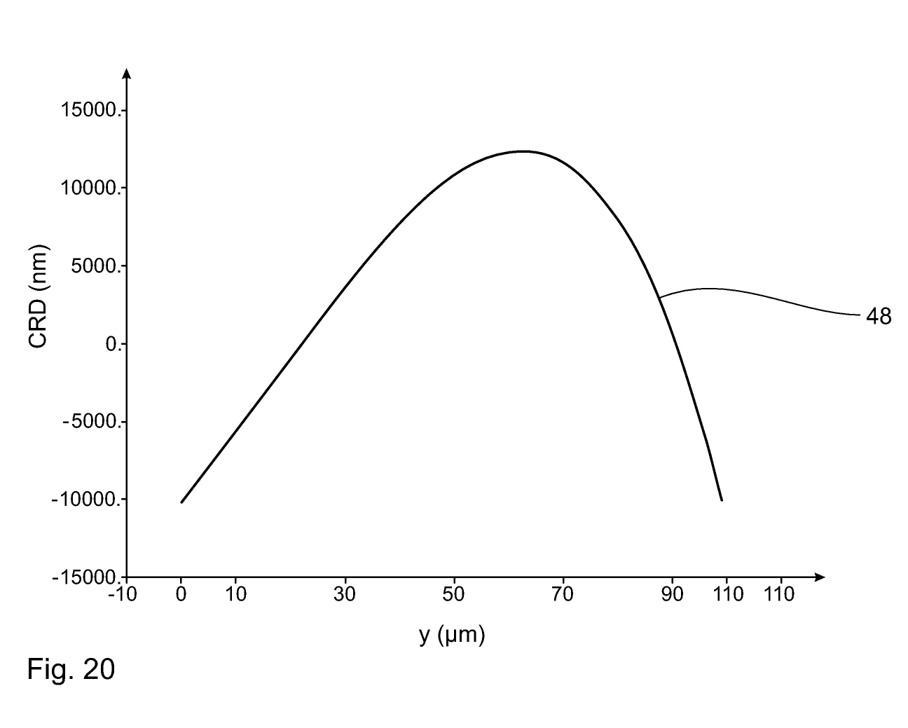

FIG. 20 shows, in an illustration similar to FIG. 4, the dependence of the chief ray distortion CRD against the field height y for the imaging optical unit according to FIG. 19; and

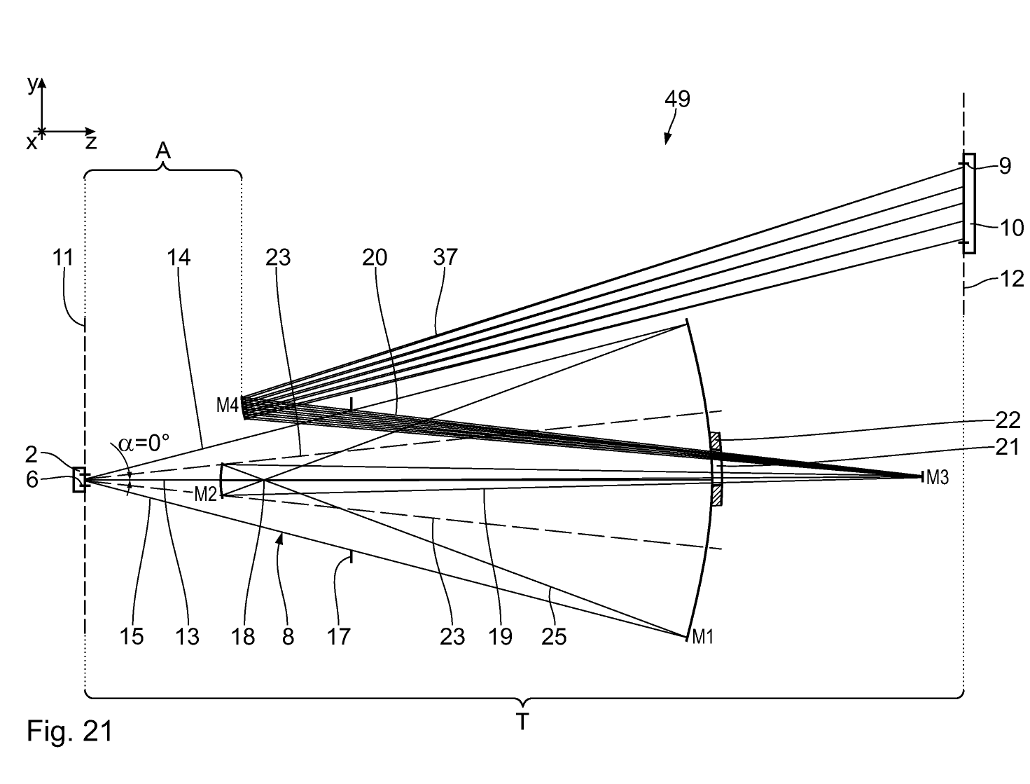

FIGS. 21 to 31 show, in an illustration similar to FIG. 3, further embodiments of the imaging optical unit.

FIG. 1 shows, highly schematically, a metrology system 1 for examining an object 2 in the form of a reticle or a lithography mask for EUV projection lithography. The metrology system 1, which is also referred to as APMI (Actinic Patterned Mask Inspection), can be used to examine, in particular, defects on the reticle 2 and the effects thereof on imaging in EUV projection lithography. The reticle 2 can be checked, in particular, for patterning errors. The patterning error can subsequently be examined with the aid of an analysis of a so-called aerial image (Aerial Image Metrology System, AIMS). AIMS systems are known from DE 102 20 815 A1. The metrology system 1 is used for examining a reflective reticle 2.

In order to facilitate the representation of positional relationships, a Cartesian xyz coordinate system is used below. The x-axis runs perpendicularly to the plane of the drawing out of the latter in FIG. 1. The y-axis runs towards the right in FIG. 1. The z-axis runs upwards in FIG. 1.

The metrology system 1 has an EUV light source 3 for generating illumination and imaging light 4. The EUV light source can be a plasma source, that is to say an LPP source (laser produced plasma), or a GDP source (gas discharge produced plasma). The EUV light source 3 can also be an EUV laser. The latter can be realised for example by frequency multiplication of longer-wave laser radiation. The EUV light source 3 emits usable illumination and imaging light 4 having a wavelength of 13.5 nm. Other wavelengths in the range of between 5 nm and 100 nm, in particular in the range of between 5 nm and 30 nm, can also be used as illumination and imaging light 4 given a corresponding design of the EUV light source 3.

An illumination optical unit 5 serves for transferring the illumination and imaging light 4 from the EUV light source 3 towards an object field 6, in which a segment of the reflective reticle 2 is arranged.

An imaging optical unit 7 having a high magnification factor, for example of 500, images the object field 6 into an image field 9 via an imaging beam path 8. A spatially resolving detection device in the form of a CCD sensor 10 detects an intensity distribution of the illumination and imaging light 4 over the image field 9. A CCD chip of the CCD sensor 10 can be embodied as a time delay and integration CCD chip (time delay and integration charge-coupled device, TDI CCD). A TDI CCD chip can be used, in particular, for examining a reticle 2 moved through the object field 6. A movement direction of the reticle 2 can run along the y-direction.

Illumination and detection of the illumination and imagine light 4 emerging from the object field 6 can take place in various ways. In the case of the metrology system according to FIG. 1, illumination is effected with a numerical aperture NA of 0.25, for example. The imaging optical unit 7 can capture this numerical aperture completely or partially, depending on the embodiment. Assuming a perfectly reflective reticle 2, therefore, the entire illumination and imaging light 4 reflected from the reticle 2 or part of said light can be captured by the imaging optical unit 7. Such illumination is also known as bright field illumination. Dark field illumination is also possible, in which portions of the illumination and imaging light 4 that are exclusively scattered or diffracted by the reticle 2 are detected by the CCD sensor 10.

FIG. 2 shows a variant of the metrology system 1 that is used for examining a reticle 2 that is at least partly transmissive to the illumination and imaging light 4, for example for a phase shift mask. Components corresponding to those which have already been explained above with reference to FIG. 1 bear the same reference numerals and will not be discussed in detail again.

In contrast to the embodiment according to FIG. 1, in the case of the metrology system 1 according to FIG. 2, the imaging optical unit 7 is not arranged in the direction of a reflected beam path of the illumination and imaging light 4, but rather in the direction of a beam path transmitted through the reticle 2. In this case, too, bright field or dark field illumination is possible depending on the embodiment of the illumination optical unit 5 and/or the imaging optical unit 7.

FIG. 3 shows an embodiment of the imaging optical unit 7 that can be used in the metrology system 1 in FIG. 1 or 2. Components that have already been explained above in connection with the description of the metrology system 1 bear the same reference numerals and will not be discussed in detail again. A Cartesian xyz coordinate system is also used in connection with the description of the imaging optical unit 7 according to FIG. 3 and with the description of the further embodiments for the imaging optical unit. The x-axis runs perpendicularly to the plane of the drawing into the latter in FIG. 3. The y-axis runs upwards in FIG. 3. The z-axis runs towards the right in FIG. 3.

The imaging optical unit 7 according to FIG. 3 images the object field 6 lying in an object plane 11 into the image field 9 lying in an image plane 12 with a magnification factor of 750.

FIG. 3 illustrates, for the visualization of the imaging beam path 8 of the imaging optical unit 7, the course of chief rays 13 and of coma rays 14, 15 which emerge from five object field points lying one above another in the y-direction. The distance between said object field points in the y-direction is so small in the object field 6 that said distance cannot be resolved in the drawing. These five object field points are imaged into five image field points lying one above another in FIG. 3 in the image field 9, which are resolved separately in the drawing on account of the high magnification factor. The chief rays 13, on the one hand, and the coma rays 14, 15, on the other hand, are also designated as imaging rays hereinafter.

The object field 6, on the one hand, and the image field 9, on the other hand, lie in xy planes spaced apart from one another. The object field 6 has an extent of 40 μm in the y-direction and an extent of 200 μm in the x-direction, that is to say has a field size of 40×200 μm². The object field 6 and the image field 9 are rectangular in each case.

The chief rays 13 emerge in the imaging beam path 8 between the object field 6 and the image field 9 from the object field 6 with a chief ray angle α of almost 0° with respect to a normal 16—running in the z-direction—to a central object field point of the object plane 11. On account of this practically vanishing chief ray angle α, that is to say on account of the almost perpendicular course of the chief rays 13 on the reticle 2, the imaging optical unit 7 according to FIG. 3 can be used for dark field illumination in the metrology system 1 according to FIG. 2. The chief ray angle α is less than 1°. Other chief ray angles α, in particular a larger chief ray angle α, are possible.

An object-field-side numerical aperture of the imaging optical unit 7 is NAO=0.25.

In the image plane 12, the imaging rays 13 to 15 meet almost perpendicularly to the image plane 12 respectively at one of the five image field points of the image field 9. The chief rays 13 associated with each of the image field points run parallel to one another. The imaging optical unit 7 according to FIG. 3 is therefore telecentric on the image side.

In the imaging beam path between the object field 6 and the image field 9, the imaging optical unit 7 has exactly four mirrors, which are designated hereinafter by M1, M2, M3 and M4 in the order in which they are arranged in the imaging beam path. The four mirrors M1 to M4 constitute four optical components that are separate from one another.

An aperture stop 17 is arranged in the beam path between the object field 6 and the mirror M1. The aperture stop 17 is arranged in the region of a first pupil plane of the imaging optical unit 7 according to FIG. 3 between the object field 6 and the mirror M1. A second pupil plane of the imaging optical unit 7 according to FIG. 3 lies in the imaging beam path 8 between the mirror M2 and the mirror M3.

The first mirror M1 in the beam path between the object field 6 and the image field 9 is embodied aspherically as a concave primary mirror and the further mirrors M2 to M4 are embodied spherically. The mirror M2 is configured in concave fashion, the mirror M3 is configured in convex fashion and the mirror M4 is configured in concave fashion.

FIG. 3 illustrates the curves of intersection of parent surfaces which are used for the mathematical modelling of the reflection surfaces of the mirrors M1 to M4. Those regions of the reflection surfaces of the mirrors M1 to M4 to which the coma rays 14, 15 are applied and between the coma rays 14, 15 imaging radiation is actually applied are actually physically present in the sectional plane illustrated.

An intermediate image 18 lies in the imaging beam path between the mirrors M1 and M2.

The imaging optical unit 7 is designed for an operating wavelength of 13.5 nm.

The mirrors M1 to M4 bear a coating that is highly reflective to the illumination imaging light 4, which coating can be embodied as a multilayer coating.

A first imaging partial ray 19 lies in the imaging beam path 8 between the second mirror M2 and the third mirror M3. A second imaging partial ray 20 lies in the imaging beam path 8 between the third mirror M3 and the fourth mirror M4. The two imaging partial rays 19 and 20 both pass through a passage opening 21 into a mirror body 22 of the first mirror M1 in the imaging beam path 8. The mirror body 22 is schematically illustrated only in the vicinity of the passage opening 21 in FIG. 3. The two imaging partial rays 19, 20 pass through one and the same passage opening 21.

The passage opening 21 is completely shaded by the mirror M2 in the imaging beam path 8. This is illustrated in FIG. 3 by two dashed shadow lines 23 which run in each case from the object field 6 as far as the mirror M1 and the course of which is defined by the shading edge of the mirror M2.

An imaging partial ray 24 between the object field 6 and the first mirror M1 passes through the aperture stop 17, wherein the aperture stop 17 defines the marginal extent of the imaging partial ray 24. In addition, a further imaging partial ray 25 of the imaging beam path 8 between the mirror M1 and the mirror M2 and also the first imaging partial ray 19 pass through the aperture stop 17.

Optical data of the imaging optical unit 7 according to FIG. 3 are reproduced below with the aid of two tables. In the column “Radius”, the first table shows the respective radius of curvature of the mirrors M1 to M4. The third column (Thickness) describes the distance in each case to the downstream surface in the z-direction.

The second table describes the exact aspherical surface shape of the reflection surfaces of the mirror M1, wherein the constants K and A to E should be inserted into the following equation for the sagitta:

$$z ( h ) = \frac{{ch}^{2}}{1 + SQRT \{ 1 - ( 1 + K ) {c}^{2} {h}^{2} \}} + {Ah}^{4} + {Bh}^{6} + {Ch}^{8} + {Dh}^{10} + {Eh}^{12} ( + {Fh}^{14} + {Gh}^{16} )$$

In this case, h represents the distance from the optical axis, that is to say from the normal 16, of the imaging optical unit 7. h²=x²+y² therefore holds true. The reciprocal of “Radius” is inserted into the equation for c.

| Surface | Radius | Thickness | Operating mode |
|---|---|---|---|
| Object | Infinite | 341.321 | |
| Stop | Infinite | 458.679 | |
| M1 | −661.396 | −587.218 | REFL |
| M2 | 45.279 | 606.973 | REFL |
| M3 | 37.363 | −719.756 | REFL |
| M4 | 1492.495 | 778.296 | REFL |
| Image | Infinite | 0.000 | |
| Surface | K | A | B |
| M1 | 0.000000E+00 | 1.646127E−11 | 3.681016E−17 |
| Surface | C | D | E |
| M1 | 7.950565E−23 | 9.621018E−29 | 1.101070E−33 |

A structural length T, that is to say, depending on the embodiment of the imaging optical unit, a distance between the object plane 11 and the image plane 12 or the distance between the components of the imaging optical unit 7 that are furthest away from each other in the z-direction, is 878 mm. With respect to this definition of the structural length T, the object field 6 and the image field 9 also are components of the imaging optical unit. A ratio of the structural length T and the imaging scale β is 878 mm/750=1.17 mm.

The distance between the last mirror M4 and the image field 9 is more than 88 percent of the structural length T.

FIG. 4 shows in a diagram the dependence of a chief ray distortion CRD in nm on the field height y of the object field 6 of the imaging optical unit 7 according to FIG. 3. A distortion profile 26 is approximately parabolic with a minimum of CRD≈−280 nm at a field height y≈23 μm. The highest distortion value CRD≈360 nm is achieved at a field height y=0. At the other field edge, that is to say at the field height y=40 μm, the distortion CRD≈125 nm. Over the entire y-field height of the object field 6, the distortion CRD in absolute terms is therefore less than 400 nm. Given a pixel size of the CCD sensor 10 of 10 μm×10 μm, the imaging optical unit 7 is therefore corrected well. On account of the rotational symmetry of the imaging optical unit 7 about the optical axis, a corresponding dependence of the distortion CRD on the x-dimension arises.

In the case of the imaging optical unit 7, the etendue (aperture×field size) required for the metrology system 1 can be corrected in a diffraction-limited and distortion-free manner.

With reference to FIGS. 5 and 6, a description is given below of a further embodiment of an imaging optical unit 27, which can be used instead of the imaging optical unit 7 according to FIG. 3. Components and functions corresponding to those which have already been explained in the previous figures bear the same reference numerals and will not be discussed in detail again. The differences relative to the previous exemplary embodiment are explained below.

The imaging optical unit 27 has an object-side chief ray angle α between the normal 16 to the object plane 11 and the chief ray 13 of a central object field point of 10°. The imaging optical unit 27 can be used for the bright field illumination of a reflective reticle 2 in the metrology system 1 according to FIG. 1. Given an illumination aperture chosen to be appropriately small in the illumination optical unit 5, which is indicated schematically in FIG. 5, a zeroth diffraction order of the illumination imaging light 4 reflected at the reticle 2 is not shaded particularly by the mirror M2.

The imaging optical unit 27 has a structural length T of 800 mm between the object plane 11 and the image plane 12. A distance A between the mirror M4 and the object plane 11 is more than 38 percent of the structural length T. In the case of the imaging optical unit 27, therefore, enough structural space for the illumination optical unit 5 is present in the vicinity of the object plane 11.

In the case of the imaging optical unit 27, too, the passage opening 21 lies in the shade of the mirror M2.

The chief rays 13 of different field points run divergently in the imaging beam path 8 between the last mirror M4 and the image field 9.

The ratio T/β of the structural length T and the imaging scale β (β=850) is T/β=0.94 in the case of the imaging optical unit 27.

The imaging optical unit 27 has an object-side numerical aperture of 0.24. The object field 6 of the imaging optical unit 27 has a size of 100 μm in the y-direction and 300 μm in the x-direction.

An impingement point 28 of the chief ray 13 of the central object field point on the first mirror M1 in the imaging beam path 8 and an impingement point 29 of the chief ray 13 of the central object field point on the fourth mirror M4 in the imaging beam path 8 lie on different sides of a plane 30 which is perpendicular to the meridional plane (plane of the drawing in FIG. 5) of the imaging optical unit 27 and in which the normal 16 lies. The plane 30 is therefore defined as that plane which is perpendicular to the meridional plane and contains the normal 16. The plane 30 lies between the impingement points 28 and 29.

FIG. 6 shows a CRD profile 31 over the field height y of the object field 6 in the case of the imaging optical unit 27. In the case of a field height y=0, the distortion value CRD≈−40 nm. In the case of a field height y≈20 μm, the distortion value attains a local maximum CRD≈110 nm. In the case of a field height y≈75 μm, the distortion value attains a minimum CRD≈−225 nm. At the field edge y=100 μm, the distortion attains a global maximum CRD≈175 nm. The absolute value of the distortion is therefore less than 250 nm over the entire y-field height.

The optical data of the imaging optical unit 27 according to FIG. 5 are reproduced below with the aid of two tables, which correspond in terms of structure to the tables of the imaging optical unit 7 according to FIG. 3.

| Surface | Radius | Thickness | Operating mode |
|---|---|---|---|
| Object | Infinite | 314.392 | |
| Stop | Infinite | 364.472 | |
| M1 | −536.900 | −469.274 | REFL |
| M2 | 48.401 | 570.410 | REFL |
| M3 | 45.000 | −470.410 | REFL |
| M4 | −1844.563 | 490.410 | REFL |
| Image | Infinite | 0.000 | |
| Surface | K | A | B |
| M1 | 0.000000E+00 | 4.357111E−11 | 1.480406E−16 |
| M2 | 0.000000E+00 | −1.386259E−07 | 4.004273E−12 |
| M4 | 0.000000E+00 | 2.326524E−09 | −1.752362E−14 |
| Surface | C | D | E |
| M1 | 4.934056E−22 | 9.065147E−28 | 1.077925E−32 |
| M2 | −7.308931E−14 | 1.933971E−16 | 0.000000E+00 |
| M4 | 9.974181E−20 | 0.000000E+00 | 0.000000E+00 |

In the case of the imaging optical unit 27, therefore, the mirrors M1, M2 and M4 are embodied as aspherical mirrors. The mirror M3 is embodied as a spherical mirror.

With reference to FIGS. 7 and 8, a description is given below of a further embodiment of an imaging optical unit 32, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 32 can be used in the metrology system 1 according to FIG. 1, that is to say for examining a reflective reticle 2.

The imaging beam path 8 of the imaging optical unit 32 is similar to that of the imaging optical unit 27. Between the object field 6 and the mirror M3, the imaging beam path 8 of the imaging optical unit 32 can be regarded as mirrored about the plane 30 in comparison with the imaging optical unit 27.

The impingement point 28 of the chief ray 13 of the central object field point on the first mirror M1 in the imaging beam path 8 and the impingement point 29 of the chief ray of the central object field point on the fourth mirror M4 in the imaging beam path 8 lie on the same side of the plane 30. In the case of the imaging optical unit 32, therefore, the fourth mirror M4 is not structure-space-limiting for the illumination optical unit 5, which is indicated schematically in FIG. 7.

Instead of a single passage opening 21 in the mirror body 22, two passage openings 21a, 21b are embodied in the mirror body 22 of the mirror M1 in the case of the imaging optical unit 32. Through the passage opening 21a, the first imaging partial ray 19 between the mirrors M2 and M3 passes through the mirror body 22. Through the further passage opening 21b, the imaging partial ray 20 between the mirrors M3 and M4 passes through the mirror body 22.

The passage opening 21a is shaded by the mirror M2.

The imaging light partial rays 24, 25, 19 and additionally the second imaging light partial ray 20 pass through the aperture stop 17.

The imaging optical unit 32 has a structural length T of 741 mm. A ratio between the distance A between the mirror M4 and the object plane 11 and the structural length T is A/T≈0.28. The ratio T/β of the structural length T and the imaging scale β (β=850) is T/β=0.87 in the case of the imaging optical unit 32.

The optical data of the imaging optical unit 32 according to FIG. 7 are reproduced below with the aid of two tables, which correspond in terms of structure to the tables of the imaging optical unit 7 according to FIG. 3.

| Surface | Radius | Thickness | Operating mode |
|---|---|---|---|
| Object | Infinite | 299.082 | |
| Stop | Infinite | 321.628 | |
| M1 | −467.134 | −400.711 | REFL |
| M2 | 49.955 | 500.811 | REFL |
| M3 | 45.000 | −501.728 | REFL |
| M4 | −1007.185 | 521.728 | REFL |
| Image | Infinite | 0.000 | |
| Surface | K | A | B |
| M1 | 0.000000E+00 | 8.920370E−11 | 3.897637E−16 |
| M2 | 0.000000E+00 | −2.340808E−07 | −8.443464E−11 |
| M4 | 0.000000E+00 | 3.951304E−09 | −3.068802E−14 |
| Surface | C | D | E |
| M1 | 1.859259E−21 | 2.937370E−27 | 6.606394E−32 |
| M2 | 1.060639E−13 | −1.686228E−16 | 0.000000E+00 |
| M4 | 1.570060E−19 | 0.000000E+00 | 0.000000E+00 |

FIG. 8 shows a profile 33 of the chief ray distortion CRD against the field height y. In principle, the CRD profile 33 of the imaging optical unit 32 according to FIG. 7 is similar to the CRD profile 31 of the imaging optical unit 27 according to FIG. 5. In the case of a field height of y=0, a chief ray distortion CRD of 0 μm is present. In the case of a field height y≈15 μm, a local maximum of the chief ray distortion of CRD≈700 nm is present. In the case of a field height y≈70 μm, a minimum of the chief ray distortion of CRD≈−1400 nm is present. In the case of a field height y≈100 μm, a global maximum of the chief ray distortion CRD≈1400 nm is present. The absolute chief ray distortion is not greater than 1500 nm over the entire y-field height.

With reference to FIGS. 9 and 10, a description is given below of a further embodiment of an imaging optical unit 34, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 34 has two intermediate images, namely alongside the intermediate image 18 also a further intermediate image 35 in the imaging beam path between the mirrors M3 and M4.

A further pupil plane 36 lies between the second intermediate image 35 and the image field 9, said further pupil plane representing an image of the plane in which the aperture stop 17 is arranged. Adjacent to the pupil plane 36 arranged in the imaging beam path 8 between the mirror M4 and the image field 9, an imaging partial ray 37 between the mirror M4 and the image field 9 has a small diameter in comparison with the transverse dimensions of the image field 9. The imaging partial ray 37 is the third imaging partial ray that passes through the mirror body 22 of the mirror M1 of the imaging optical unit 34, and is therefore also referred to as third imaging partial ray 37.

Similarly to the embodiment of the imaging optical unit 32, the mirror body 22 of the mirror M1 has two passage openings 21a, 21b. The first imaging partial ray 19 and the second imaging partial ray 20 pass through the passage opening 21a. The third imaging partial ray 37 passes through the passage opening 21b. The passage opening 21a is completely shaded by the mirror M2. An additional obscuration of the imaging beam path 8 by the passage opening 21b is small on account of the small diameter of the passage opening 21b.

The imaging optical unit 39 has a structural length T of 800 mm

A ratio between the distance A between the mirror M4 and the object plane 11 and the structural length T is A/T=0.24.

In the case of the imaging optical unit 34, the chief rays 13 run divergently between the pupil plane 36 and the image field 9.

On account of the imaging beam path being folded at the mirror M4 back in the direction of the mirror M1, this results in an overall very compact imaging optical unit 34 in the y-direction. A distance B between points of the mirrors M1 to M4, of the object field 6 and of the object field 9 which are furthest away from one another in the y-direction and to which imaging radiation is applied is therefore small. The ratio B/T is 0.41 in the case of the imaging optical unit 34.

The optical data of the imaging optical unit 34 according to FIG. 9 are reproduced below with the aid of two tables, which correspond in terms of structure to the tables of the imaging optical unit 7 according to FIG. 3.

| Object | Infinite | 376.829 | |
|---|---|---|---|
| Stop | Infinite | 423.171 | |
| M1 | −680.112 | −620.000 | REFL |
| M2 | 54.939 | 719.999 | REFL |
| M3 | 45.614 | −619.999 | REFL |
| M4 | 468.493 | 947.141 | REFL |
| Image | Infinite | 0.000 | |
| Surface | K | A | B |
| M1 | 0.000000E+00 | 1.271439E−11 | 2.758381E−17 |
| M2 | 0.000000E+00 | 5.407597E−08 | 7.532271E−11 |
| M4 | 0.000000E+00 | −5.313806E−10 | −1.465797E−15 |
| Surface | C | D | E |
| M1 | 5.668265E−23 | 7.895876E−29 | 4.584057E−34 |
| M2 | −1.079043E−14 | 9.519225E−17 | 0.000000E+00 |
| M4 | −8.252054E−21 | 0.000000E+00 | 0.000000E+00 |

FIG. 10 shows a chief ray distortion profile or CRD profile 38 over the field height y of the object field 6 of the imaging optical unit 34. In principle, this CRD profile is similar to that according to FIGS. 6 and 8, wherein, in contrast to those profiles, the CRD profile 38 falls to smaller absolute values again at the right-hand field edge in FIG. 10. In the case of the field height y≈0, the chief ray distortion CRD z≈−15 nm. In the case of the field height y≈20 μm, the chief ray distortion CRD≈30 nm and has a local maximum there. In the case of the field height y≈55 μm, the CRD profile 38 has a global minimum at CRD y≈−18 nm. In the case of the field height y≈90 μm, the CRD profile has a global maximum at CRD≈40 μm. In absolute terms, the chief ray distortion is always less than 40 nm within the entire y-field height.

In the case of the imaging optical unit 34, the impingement points 28, 29 again lie on different sides of the plane 30.

With reference to FIGS. 11 and 12, a description is given below of a further embodiment of an imaging optical unit 39, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

In comparison with the imaging optical unit 34, the imaging optical unit 39 is mirrored by part of its imaging beam path 8 about the plane 30 in a comparable manner to that as explained above in the comparison of the imaging optical units 27 and 32 according to FIGS. 5 and 7. In the case of the imaging optical unit 39, the imaging partial rays 19 and 20 pass through the passage opening 21 of the mirror body 22 of the mirror M1. The imaging partial ray 37 runs past the mirror M1, that is to say does not pass through the mirror body 22 of the mirror M1.

All the imaging partial rays 24, 25, 19, 20 and 37 of the imaging beam path 8 pass through the aperture stop 17.

The impingement points 28 and 29 both lie on the same side of the plane 30.

The imaging optical unit 39 has a structural length T of 800 mm and a magnification scale β of 850. The ratio T/β is 0.94 as in the case of the imaging optical unit 27 according to FIG. 5.

The optical data of the imaging optical unit 39 according to FIG. 11 are reproduced below with the aid of two tables, which correspond in terms of structure to the tables of the imaging optical unit 7 according to FIG. 3.

| Surface | Radius | Thickness | Operating mode |
|---|---|---|---|
| Object | Infinite | 301.306 | |
| Stop | Infinite | 379.389 | |
| M1 | −559.837 | −500.696 | REFL |
| M2 | 48.560 | 600.000 | REFL |
| M3 | 40.000 | −680.000 | REFL |
| M4 | 409.424 | 700.000 | REFL |
| Image | Infinite | 0.000 | |
| Surface | K | A | B |
| M1 | 0.000000E+00 | 2.965442E−11 | 9.292083E−17 |
| M2 | 0.000000E+00 | −2.649999E−08 | 3.216689E−11 |
| M4 | 0.000000E+00 | −1.131277E−09 | −3.568456E−15 |
| Surface | C | D | E |
| M1 | 2.937853E−22 | 5.132600E−28 | 5.061928E−33 |
| M2 | 8.859961E−14 | 0.000000E+00 | 0.000000E+00 |
| M4 | −2.085254E−20 | 0.000000E+00 | 0.000000E+00 |

FIG. 12 shows a CRD profile 40 of the imaging optical unit 39 over the field height y of the object field 6.

In the case of the field height y≈0, the distortion CRD≈5 nm. In the case of the field height y≈30 μm, the distortion CRD≈−40 nm and has a local minimum there. In the case of the field height y≈80 μm, the distortion CRD≈150 nm and has a global maximum there. In the case of the field height y≈100 μm, the distortion CRD≈−60 μm. The chief ray distortion CRD is less than 150 nm in absolute terms over the entire y-field height of the object field 6 of the imaging optical unit 39.

With reference to FIGS. 13 and 14, a description is given below of a further embodiment of an imaging optical unit 41, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 41 differs from the imaging optical unit 27 according to FIG. 5 principally in that the mirror M2 is embodied in convex fashion and the third mirror M3 is embodied in concave fashion. The intermediate image 18 is arranged between the mirrors M3 and M4 in the case of the imaging optical unit 41.

The mirrors M1 and M2 are configured in aspherical fashion and the mirrors M3 and M4 are configured in spherical fashion.

The imaging optical unit 41 has a size of the object field 6 of 100 μm in the y-direction and of 400 μm in the x-direction. The imaging optical unit 41 has a magnification factor (scale) of 850. The imaging optical unit 41 has a structural length T of 800 mm. The ratio T/β is 0.93. The object-side chief ray angle α is 10°.

The optical data of the imaging optical unit 41 according to FIG. 13 are reproduced below with the aid of two tables, which correspond in terms of structure to the tables of the imaging optical unit 7 according to FIG. 3.

| Surface | Radius | Thickness | Operating mode |
|---|---|---|---|
| Object | Infinite | 258.727 | |
| Stop | Infinite | 378.264 | |
| M1 | −543.947 | −456.991 | REFL |
| M2 | −36.455 | 557.137 | REFL |
| M3 | −40.703 | −637.137 | REFL |
| M4 | 1563.169 | 691.213 | REFL |
| Image | Infinite | 0.000 | |
| Surface | K | A | B |
| M1 | 0.000000E+00 | 1.033316E−11 | 3.279920E−17 |
| M2 | 1.308094E−01 | 0.000000E+00 | −5.196086E−10 |
| Surface | C | D | E |
| M1 | 1.148946E−22 | 1.623072E−28 | 2.445232E−33 |
| M2 | 0.000000E+00 | 0.000000E+00 | 0.000000E+00 |

FIG. 14 shows a CRD profile 42 of the imaging optical unit 41 over the field height y of the object field 6.

In the case of the field height y≈0, the distortion CRD≈170 nm. In the case of the field height y≈65 μm, the distortion CRD≈−250 nm and has a global minimum there. In the case of the field height y≈110 μm, the distortion CRD≈170 nm. The chief ray distortion CRD is less than 260 nm in absolute terms over the entire y-field height of the object field 6 of the imaging optical unit 41.

With reference to FIGS. 15 and 16, a description is given below of a further embodiment of an imaging optical unit 43, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

In comparison with the imaging optical unit 41, the imaging optical unit 43 is mirrored by part of its imaging beam path 8 about the plane 30 in a comparable manner to that as explained above in the comparison of the imaging optical units 27 and 32 according to FIGS. 5 and 7.

The imaging optical unit 43 has a structural length T of 786 mm and a magnification scale β of 850. The ratio T/β is 0.92.

The optical data of the imaging optical unit 43 according to FIG. 15 are reproduced below with the aid of two tables, which correspond in terms of structure to the tables of the imaging optical unit 7 according to FIG. 3.

| Surface | Radius | Thickness | Operating mode |
|---|---|---|---|
| Object | Infinite | 258.747 | |
| Stop | Infinite | 377.289 | |
| M1 | −542.906 | −456.036 | REFL |
| M2 | −36.246 | 556.120 | REFL |
| M3 | −40.479 | −636.120 | REFL |
| M4 | 1547.952 | 685.587 | REFL |
| Image | Infinite | 0.000 | |
| Surface | K | A | B |
| M1 | 0.000000E+00 | 1.049517E−11 | 3.354943E−17 |
| M2 | 1.285065E−01 | 0.000000E+00 | −6.437537E−10 |
| Surface | C | D | E |
| M1 | 1.086720E−22 | 2.589792E−28 | 2.021330E−33 |
| M2 | 0.000000E+00 | 0.000000E+00 | 0.000000E+00 |

FIG. 16 shows a CRD profile 44 of the imaging optical unit 43 against the field height y of the object field 6. This field height profile is similar to the CRD profile 42 according to FIG. 14.

In the case of the field height y≈0, the distortion CRD≈200 nm. In the case of the field height y≈70 μm, the distortion CRD≈−300 nm and has a global minimum there. In the case of the field height y≈100 μm, the distortion CRD≈250 nm. The chief ray distortion CRD is less than 330 nm in absolute terms over the entire y-field height of the object field 6 of the imaging optical unit 43.

With reference to FIGS. 17 and 18, a description is given below of a further embodiment of an imaging optical unit 45, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

In the case of the imaging optical unit 45, no intermediate image is present between the object field 6 and the image field 9 in the imaging beam path 8. The mirrors M2 and M3 are configured in convex fashion.

The imaging optical unit 45 has a structural length T of 1050 mm and a magnification scale β in absolute terms of 850. The ratio T/β is 1.24.

The optical data of the imaging optical unit 45 according to FIG. 17 are reproduced below with the aid of two tables, which correspond in terms of structure to the tables of the imaging optical unit 7 according to FIG. 3.

| Surface | Radius | Thickness | Operating mode |
|---|---|---|---|
| Object | Infinite | 256.742 | |
| Stop | Infinite | 373.890 | |
| M1 | −545.447 | −450.631 | REFL |
| M2 | −61.991 | 820.000 | REFL |
| M3 | 59.543 | −900.000 | REFL |
| M4 | 2477.069 | 950.000 | REFL |
| Image | Infinite | 0.000 | |
| Surface | K | A | B |
| M1 | 0.000000E+00 | 4.197072E−12 | 6.316517E−19 |
| M2 | 1.125022E−01 | 0.000000E+00 | −1.570881E−10 |
| Surface | C | D | E |
| M1 | 7.807468E−23 | −6.468616E−28 | 3.776136E−33 |
| M2 | 0.000000E+00 | 0.000000E+00 | 0.000000E+00 |

FIG. 18 shows a CRD profile 46 of the imaging optical unit 45 against the field height y of the object field 6.

In the case of the field height y≈0, the distortion CRD≈30 μm. Up to the field height y≈10 μm, the distortion remains practically unchanged. In the further profile, the distortion falls to a value CRD≈−62 μm. The chief ray distortion CRD is less than 63 μm in absolute terms over the entire y-field height of the object field 6 of the imaging optical unit 45.

With reference to FIGS. 19 and 20, a description is given below of a further embodiment of an imaging optical unit 47, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

In comparison with the imaging optical unit 45 according to FIG. 17, the imaging optical unit 47 according to FIG. 19 is mirrored by part of its imaging beam path 8 about the plane 30 in a comparable manner to that as explained above in the comparison of the imaging optical units 27 and 32 according to FIGS. 5 and 7.

In the case of the imaging optical unit 47, the mirrors M2, M3 and M4 are configured as convex mirrors.

The imaging optical unit 47 has a structural length T of 800 mm and a magnification scale β in absolute terms of 850. The ratio T/β is 0.94 as in the case of the imaging optical units 27 and 39.

The optical data of the imaging optical unit 47 according to FIG. 19 are reproduced below with the aid of two tables, which correspond in terms of structure to the tables of the imaging optical unit 7 according to FIG. 3.

| Surface | Radius | Thickness | Operating mode |
|---|---|---|---|
| Object | Infinite | 248.571 | |
| Stop | Infinite | 374.783 | |
| M1 | −555.686 | −443.354 | REFL |
| M2 | −126.546 | 617.636 | REFL |
| M3 | 144.878 | −697.636 | REFL |
| M4 | −214.474 | 700.000 | REFL |
| Image | Infinite | 0.000 | |
| Surface | K | A | B |
| M1 | 0.000000E+00 | −1.227299E−11 | −4.503697E−17 |
| M2 | 4.927422E−01 | 0.000000E+00 | −1.277664E−12 |
| M3 | 0.000000E+00 | 6.607818E−08 | −2.188416E−12 |
| Surface | C | D | E |
| M1 | −1.152684E−22 | −2.486658E−28 | −2.171236E−33 |
| M2 | 9.892206E−16 | 0.000000E+00 | 0.000000E+00 |
| M3 | 0.000000E+00 | 0.000000E+00 | 0.000000E+00 |

FIG. 20 shows a CRD profile 48 of the imaging optical unit 47 against the field height y of the object field 6.

In the case of the field height y≈0, the distortion CRD≈−10 μm. In the case of the field height≈65 μm, the distortion CRD≈12.5 μm and has a global maximum there. In the case of the field height y≈100 μm, the distortion CRD≈−10 μm. The chief ray distortion CRD is less than 12.5 μm over the entire y-field height of the object field 6 of the imaging optical unit 47.

With reference to FIG. 21, a description is given below of a further embodiment of an imaging optical unit 49, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

In comparison with the imaging optical unit 7 according to FIG. 3, the imaging optical unit 49 according to FIG. 21 has lower incidence angles of the imaging rays of the imaging beam path 8 on the mirror M3.

The imaging optical unit 49 has a structural length T of 1088 mm between the object plane 11 and the image plane 12. A distance A between the mirror M4 and the object plane is more than 17% of the structural length T.

The passage opening 21 lies in the shade of the mirror M2.

The chief rays 13 of different field points run divergently in the imaging beam path 8 between the last mirror M4 and the image field 9.

The ratio T/β of the structural length T and the imaging scale β (β=850) is T/β=1.28 in the case of the imaging optical unit 49.

The imaging optical unit 49 has an object-side numerical aperture of 0.25. The object field 6 of the imaging optical unit 49 has a size of 106 μm in the y-direction and 680 μm in the x-direction.

The optical data of the imaging optical unit 49 according to FIG. 21 are reproduced below with the aid of two tables, which correspond in terms of structure to the tables of the imaging optical unit 7 according to FIG. 3.

| Surface | Radius | Thickness | Mode |
|---|---|---|---|
| Object | INFINITY | 328.979 | |
| STOP | INFINITY | 446.838 | |
| Mirror 1 | −646.249 | −608.573 | REFL |
| Mirror 2 | 103.429 | 870.260 | REFL |
| Mirror 3 | 96.288 | −837.504 | REFL |
| Mirror 4 | −950.126 | 887.504 | REFL |
| Image | INFINITY | 0.000 | |
| Surface | K | A | B |
| Mirror 1 | 0.000000E+00 | 2.130673E−11 | 5.114172E−17 |
| Mirror 2 | 0.000000E+00 | −1.484184E−09 | 1.588111E−12 |
| Mirror 3 | 0.000000E+00 | 1.168086E−07 | 3.806841E−11 |
| Mirror 4 | 0.000000E+00 | 2.159545E−09 | −9.203407E−15 |
| Surface | C | D | E |
| Mirror 1 | 1.117023E−22 | 2.162742E−28 | 8.660117E−34 |
| Mirror 2 | 0.000000E+00 | 0.000000E+00 | 0.000000E+00 |
| Mirror 3 | 0.000000E+00 | 0.000000E+00 | 0.000000E+00 |
| Mirror 4 | 0.000000E+00 | 0.000000E+00 | 0.000000E+00 |

In the case of the imaging optical unit 49, therefore, mirrors M1 to M4 all are embodied as aspherical mirrors.

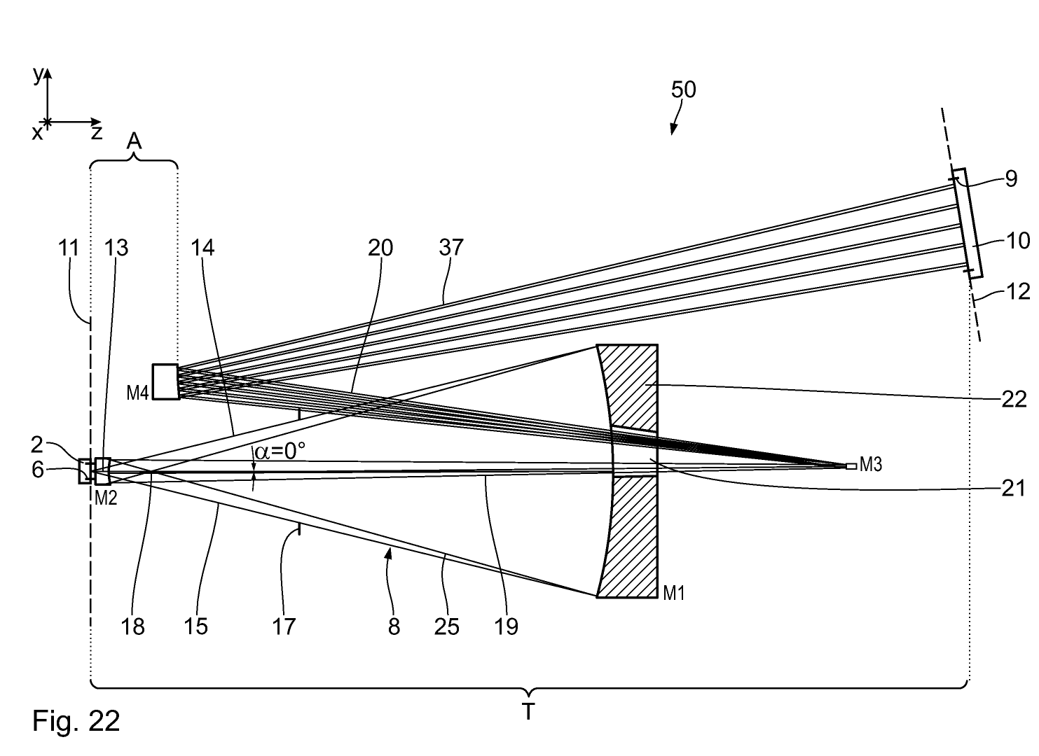

With reference to FIG. 22, a description is given below of a further embodiment of an imaging optical unit 50, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 50 is a variation of the imaging optical unit 49.

The imaging optical unit 50 has a structural length T of 1000 mm between the optic plane 11 and the image plane 12.

In the case of the imaging optical unit 50 the mirror M2 is displaced along the x-direction such that the mirror M2 does not obstruct the imaging partial ray 19 between the object field 6 and the mirror M1.

The ratio T/β of the structural length T and the imaging scale β (β=850) is T/β=1.18 in the case of the imaging optical unit 50.

The imaging optical unit 50 has an object-side numerical aperture of 0.24. The object field 6 of the imaging optical unit 50 has a size of 106 μm in the y-direction and 680 μm in the x-direction.

The optical data of the imaging optical unit 50 according to FIG. 22 are reproduced below with the aid of two tables, which correspond in terms of structure to the tables of the imaging optical unit 7 according to FIG. 3.

| Surface | Radius | Thickness | Mode |
|---|---|---|---|
| Object | INFINITY | 232.242 | |
| STOP | INFINITY | 349.832 | |
| Mirror 1 | −545.209 | −562.074 | REFL |
| Mirror 2 | 93.327 | 822.074 | REFL |
| Mirror 3 | 79.639 | −742.074 | REFL |
| Mirror 4 | −2702.878 | 900.000 | REFL |
| Image | −1669.981 | 0.000 | |

| Surface | K | A | B | C |
|---|---|---|---|---|
| Mirror 1 | 0.000000E+00 | 1.882766E−11 | 6.580594E−17 | 2.471942E−22 |
| Mirror 2 | 0.000000E+00 | 6.123538E−08 | 1.458619E−11 | 3.110235E−15 |
| Mirror 3 | 0.000000E+00 | 2.192720E−07 | 1.493226E−10 | −2.207925E−13 |

In the case of the imaging optical unit 50, therefore, the mirrors M1 to M3 are embodied as aspherical mirrors. The mirror M4 is embodied as a spherical mirror.

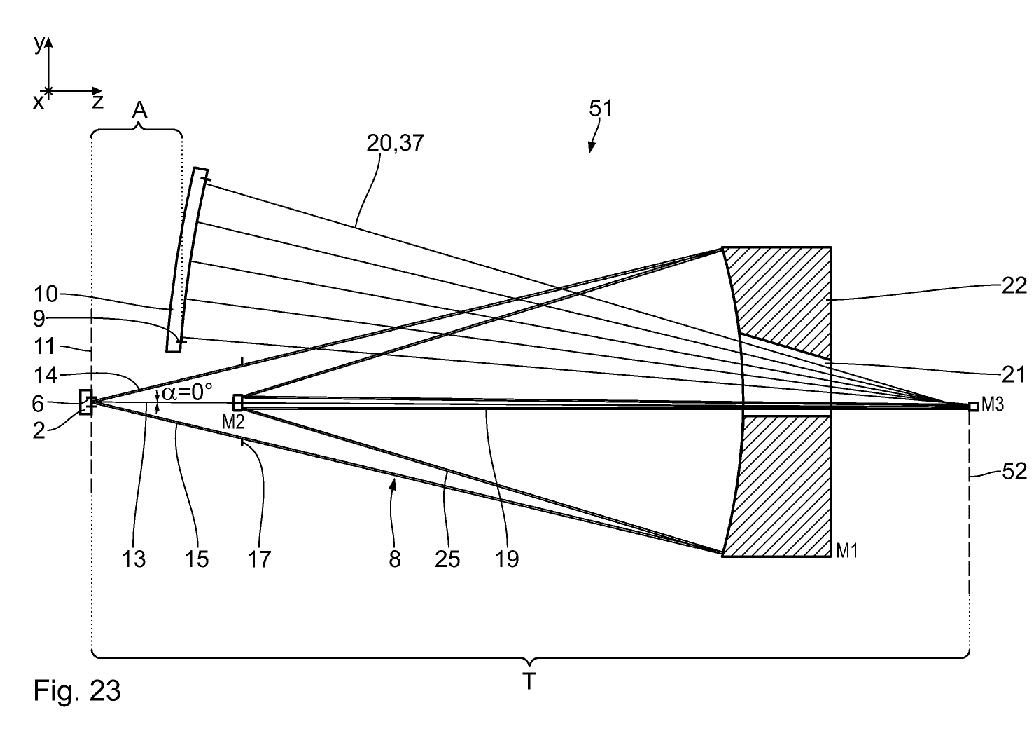

With reference to FIG. 23, a description is given below of a further embodiment of an imaging optical unit 51, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 51 has exactly three mirrors M1, M2 and M3 in the imaging beam path 8 between the object field 6 and the image field 9. The image field 9 is not a planar field but is concavely curved.

The imaging optical unit 51 has a structural length T of 1010 mm between the object plane 11 and an arrangement plane 52 being parallel to the object plane 11 and representing the position of mirror M3.

The chief rays 13 of different field points run divergently in the imaging beam path 8 between the last mirror M3 and the image field 9.

The ratio T/β of the structural length T and the imaging scale β (β=850) is T/β=1.19 in the case of the imaging optical unit 51.

The imaging optical unit 51 has an object-side numerical aperture of 0.24. The object field 6 of the imaging optical unit 51 has a size of 212 μm in the y-direction and 340 μm in the x-direction.

The optical data of imaging optical unit 51 according to FIG. 23 are reproduced below with the aid of two tables which correspond in terms of structures to the tables of the imaging optical unit 7 according to FIG. 3.

| Surface | Radius | Thickness | Mode |
|---|---|---|---|
| Object | INFINITY | 173.326 | |
| STOP | INFINITY | 576.674 | |
| Mirror 1 | −667.237 | −576.674 | REFL |
| Mirror 2 | −50.000 | 836.674 | REFL |
| Mirror 3 | −55.428 | −910.000 | REFL |
| Image | 1118.363 | 0.000 | |

| Surface | K | A | B | C | D |
|---|---|---|---|---|---|
| Mirror 1 | 0.000000E+00 | 1.239362E−12 | 2.224440E−18 | 2.381888E−24 | 2.961774E−29 |
| Mirror 2 | 0.000000E+00 | −3.373423E−07 | −2.670617E−10 | −3.891394E−13 | 1.482808E−15 |
| Mirror 3 | 0.000000E+00 | −9.836320E−08 | 0.000000E+00 | 0.000000E+00 | 0.000000E+00 |
| Image | 0.000000E+00 | −3.940290E−11 | 0.000000E+00 | 0.000000E+00 | 0.000000E+00 |

In the case of the imaging optical unit 51 all mirrors M1 to M3 are embodied as aspherical mirrors. Further, the image field 9 is aspherically curved.

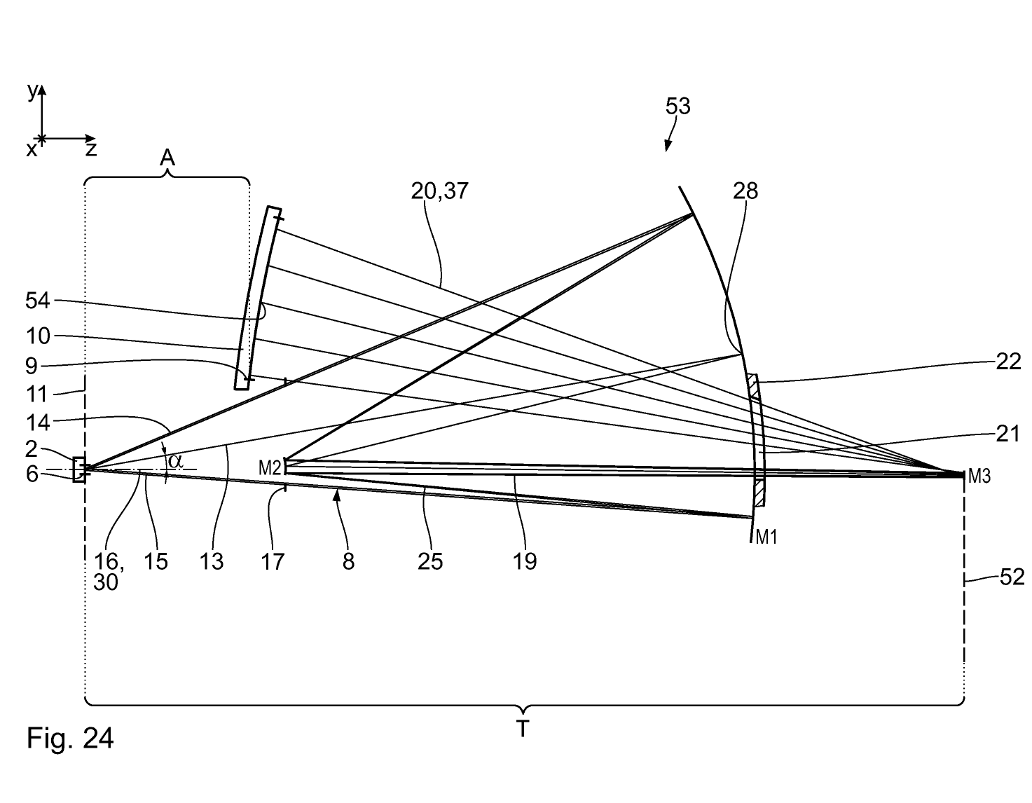

With reference to FIG. 24, a description is given below of a further embodiment of an imaging optical unit 53, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 53 has exactly three mirrors M1 to M3.

Mirror M2 is convex.

The imaging field 9 is concavely curved.

The imaging optical unit 53 has an object-side chief ray angle α between the normal 16 to the object plane 11 and the chief ray 13 of a central object field point of 10°. The imaging optical unit 53 can be used for the bright field illumination of a reflective reticle 2 in the metrology system 1 according to FIG. 1 as is explained above with reference to the imaging optical unit 27 according to FIGS. 5 and 6.

The imaging optical unit 53 has a structural length T of 1093 mm between the object plane 11 and the arrangement plane 52 of mirror M3.

The chief rays 13 of different field points run divergently in the imaging beam path 8 between the last mirror M3 and the image field 9.

The ratio T/β of the structural length T and the imaging scale β (β=850) is T/β=1.29 in the case of the imaging optical unit 53.

The imaging optical unit 53 has an object-side numerical aperture of 0.24. The object field 6 of the imaging optical unit 53 has a size of 212 μm in the y-direction and 340 μm in the x-direction.

The impingement point 28 of the chief ray 13 of the central object field point on the first mirror M1 in the imaging beam path 8 and a central image field point 54 lie on the same side of the plane 30.

The optical data of imaging optical unit 53 according to FIG. 24 are reproduced below with the aid of two tables which correspond in terms of structures to the tables of the imaging optical unit 7 according to FIG. 3.

| Surface | Radius | Thickness | Mode |
|---|---|---|---|
| Object | INFINITY | 250.000 | |
| STOP | INFINITY | 583.122 | |
| Mirror 1 | −702.563 | −583.122 | REFL |
| Mirror 2 | −50.000 | 843.212 | REFL |
| Mirror 3 | −50.219 | −893.212 | REFL |
| Image | 1814.063 | 0.000 | |

| Surface | K | A | B | C | D |
|---|---|---|---|---|---|
| Mirror 1 | −1.601482E−02 | 0.000000E+00 | −4.392992E−19 | −7.984806E−25 | −4.607245E−30 |
| Mirror 2 | 8.455222E−02 | 0.000000E+00 | −8.959759E−11 | −6.520758E−14 | −3.194743E−17 |
| Mirror 3 | −5.068107E−01 | 0.000000E+00 | −5.695781E−09 | 3.720288E−11 | −9.829453E−14 |
| Image | 0.000000E+00 | 4.003240E−09 | −5.632790E−14 | 3.962980E−19 | −1.093640E−24 |

In the case of the imaging optical unit 53, all mirrors M1 to M3 are embodied as aspherical mirrors. In addition, the image field 9 is aspherically curved.

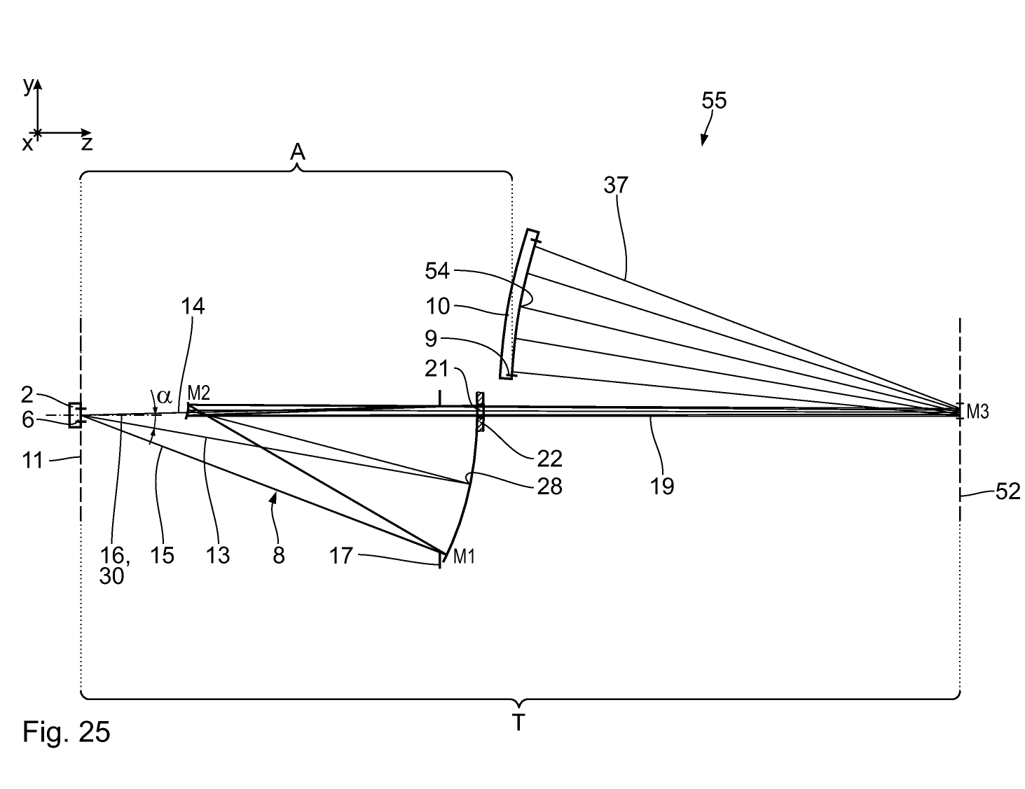

With reference to FIG. 25, a description is given below of a further embodiment of an imaging optical unit 55, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 55 has exactly three mirrors M1 to M3. The image field 9 is concavely curved. The imaging partial ray 19 between the second mirror M2 and the third mirror M3 in the imaging beam path passes through the passage opening 21 in the mirror body 22 of the first mirror M1.

The imaging optical unit 55 has an object-side chief ray angle α between the normal 16 to the object plane 11 and the chief ray 13 of a central object field point of 10°. The imaging optical unit 55 can be used for the bright field illumination.

The imaging optical unit 55 has a structural length T of 1439 mm between the object plane 11 and the arrangement plane 52 of mirror M3.

The chief rays 13 of different field points run divergently in the imaging beam path 8 between the last mirror M3 and the image field 9.

The ratio T/β of the structural length T and the imaging scale β (β=711) is T/β=2.02 in the case of the imaging optical unit 55.

The imaging optical unit 55 has an object-side numerical aperture of 0.2. The object field 6 of the imaging optical unit 55 has a size of 306 μm in the y-direction and 408 μm in the x-direction.

The impingement point 28 of the chief ray 13 of the central object field point on the first mirror M1 in the imaging beam path 8 and the central image field point 54 lie on different sides of the plane 30.

The optical data of imaging optical unit 55 according to FIG. 25 are reproduced below with the aid of two tables which correspond in terms of structures to the tables of the imaging optical unit 7 according to FIG. 3.

| Surface | Radius | Thickness | Mode |
|---|---|---|---|
| Object | INFINITY | 589.163 | |
| STOP | INFINITY | 60.837 | |
| Mirror 1 | −526.058 | −475.342 | REFL |
| Mirror 2 | 65.360 | 1263.987 | REFL |
| Mirror 3 | 56.456 | −738.645 | REFL |
| Image | 980.894 | 0.000 | |
| Surface | K | A | B |
| Mirror 1 | 0.000000E+00 | 4.300373E−11 | 1.548645E−16 |
| Mirror 2 | 0.000000E+00 | −4.824465E−08 | 1.001720E−11 |
| Mirror 3 | 0.000000E+00 | 1.064409E−07 | −8.351938E−11 |
| Image | 0.000000E+00 | −9.399710E−11 | 1.166900E−15 |
| Surface | C | D | E |
| Mirror 1 | 4.891213E−22 | 1.852110E−27 | 7.401320E−33 |
| Mirror 2 | −3.075640E−14 | 9.015706E−17 | −8.848435E−20 |
| Mirror 3 | 1.092495E−12 | −2.579340E−15 | 1.506823E−34 |
| Image | −8.581340E−21 | 3.578410E−26 | −9.483660E−32 |

In the case of the imaging optical unit 55, the mirrors M1 to M3 are embodied as aspherical mirrors. Further, image field 9 is aspherically curved.

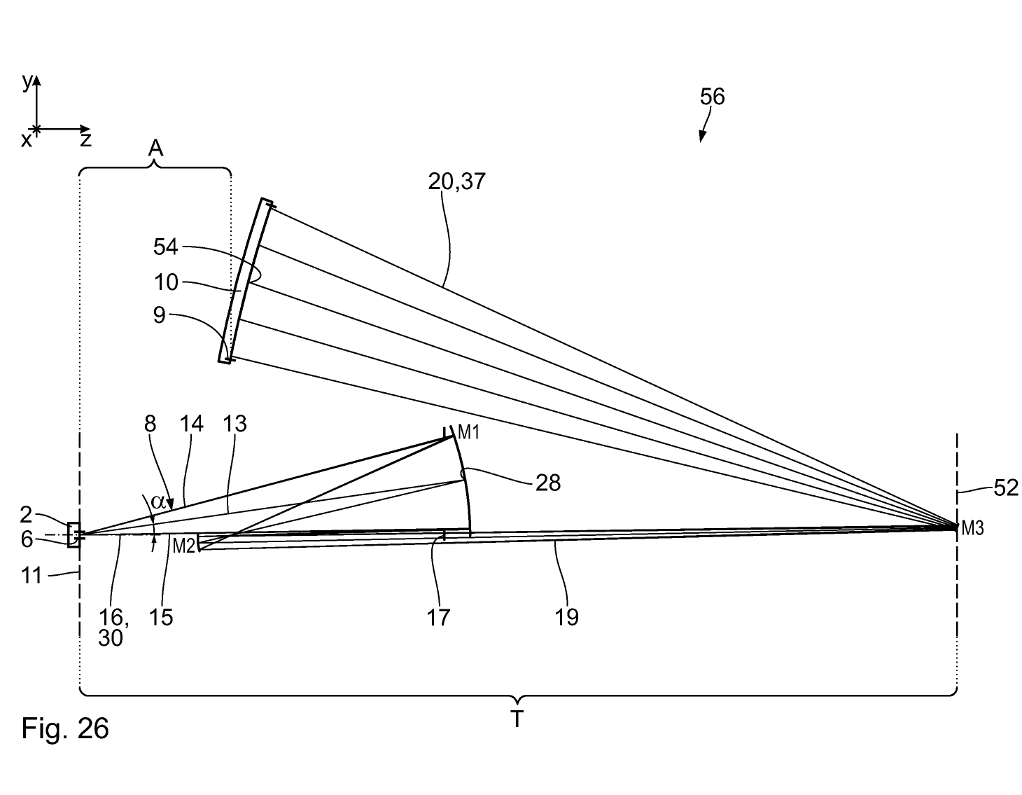

With reference to FIG. 26, a description is given below of a further embodiment of an imaging optical unit 56, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 56 has exactly three mirrors M1 to M3, none of which is obscured. None of the mirrors M1 to M3 therefore has a through-hole for imaging light to pass through. Mirror M1 may have an edge side recess for passage of the imaging partial ray 19.

The image field 9 is concavely curved.

The imaging optical unit 56 has an object-side chief ray angle α between the normal 16 to the object plane 11 and the chief ray 13 of a central object field point of 6°. The imaging optical unit 56 can be used for the bright field illumination.

The imaging optical unit 56 has a structural length T of 1300 mm between the object plane 11 and the arrangement plane 52 of mirror M3.

The chief rays 13 of different field points run divergently in the imaging beam path 8 between the last mirror M3 and the image field 9.

The ratio T/β of the structural length T and the imaging scale β (β=444) is T/β=2.93.

The imaging optical unit 56 has an object-side numerical aperture of 0.125. The object field 6 of the imaging optical unit 56 has a size of 490 μm in the y-direction and 652 μm in the x-direction.

An impingement point 28 of the chief ray 13 of the central object field point on the first mirror M1 in the imaging beam path 8 and the central image field point 54 lie on the same side of the plane 30.

The optical data of imaging optical unit 56 according to FIG. 26 are reproduced below with the aid of two tables which correspond in terms of structures to the tables of the imaging optical unit 7 according to FIG. 3.

| Surface | Radius | Thickness | Mode |
|---|---|---|---|
| Object | INFINITY | 540.146 | |
| STOP | INFINITY | 39.837 | |
| Mirror 1 | −441.759 | −404.983 | REFL |
| Mirror 2 | 92.640 | 1125.017 | REFL |
| Mirror 3 | 75.846 | −1100.017 | REFL |
| Image | 1418.455 | 0.000 | |
| Surface | K | A | B |
| Mirror 1 | 0.000000E+00 | 1.133303E−10 | 5.556978E−16 |
| Mirror 2 | 0.000000E+00 | −4.050928E−08 | −4.091379E−12 |
| Mirror 3 | 0.000000E+00 | 7.487605E−08 | −3.577094E−10 |
| Image | −1.000000E+01 | 2.773900E−10 | −2.364600E−16 |
| Surface | C | D | E |
| Mirror 1 | 3.170923E−21 | −5.865964E−27 | 2.974805E−31 |
| Mirror 2 | 4.020399E−15 | −6.638198E−18 | 4.171862E−21 |
| Mirror 3 | 1.316485E−12 | −2.503142E−15 | 1.942998E−18 |
| Image | 9.716070E−22 | −3.737610E−27 | 4.766980E−33 |

In the case of the imaging optical unit 56, the mirrors M1 to M3 are embodied as aspherical mirrors. Further, the image field 9 is aspherically curved.

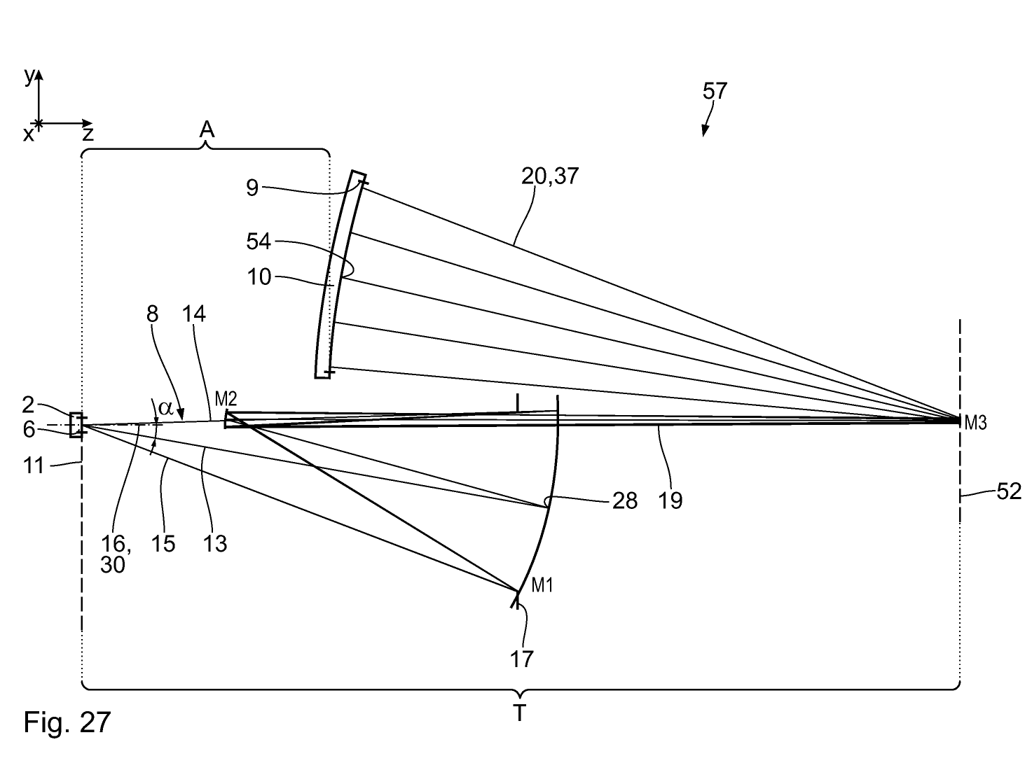

With reference to FIG. 27, a description is given below of a further embodiment of an imaging optical unit 57, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 57 corresponds to the imaging optical unit 55 according to FIG. 25. A difference is that mirror M2 of the imaging optical unit 57 is concave.

The imaging optical unit 57 has a structural length T of 1068 mm between the object plane 11 and the arrangement plane 52 of mirror M3.

The ratio T/β of the structural length T and the imaging scale β (β=711) is T/β=1.50 in the case of the imaging optical unit 57.

The optical data of imaging optical unit 57 according to FIG. 27 are reproduced below with the aid of two tables which correspond in terms of structures to the tables of the imaging optical unit 7 according to FIG. 3.

| Surface | Radius | Thickness | Mode |
|---|---|---|---|
| Object | INFINITY | 530.284 | |
| STOP | INFINITY | 49.716 | |
| Mirror 1 | −456.922 | −405.000 | REFL |
| Mirror 2 | 54.461 | 893.251 | REFL |
| Mirror 3 | 47.406 | −770.706 | REFL |
| Image | 1027.326 | 0.000 | |
| Surface | K | A | B |
| Mirror 1 | 0.000000E+00 | 7.603561E−11 | 3.602510E−16 |
| Mirror 2 | 0.000000E+00 | −1.304980E−07 | 6.663337E−12 |
| Mirror 3 | 0.000000E+00 | 1.199487E−07 | −1.899920E−09 |
| Image | −3.180656E+00 | 0.000000E+00 | 6.175220E−15 |
| Surface | C | D | E |
| Mirror 1 | 1.503883E−21 | 7.273048E−27 | 4.216415E−32 |
| Mirror 2 | −1.221818E−13 | 4.340964E−16 | −5.660438E−19 |
| Mirror 3 | 2.997983E−11 | −2.140167E−13 | 5.922798E−16 |
| Image | −5.465910E−20 | 2.002020E−25 | −1.822510E−31 |

In the case of the imaging optical unit 57, the mirrors M1 to M3 are embodied as aspherical mirrors. Further, the image field 9 is aspherically curved.

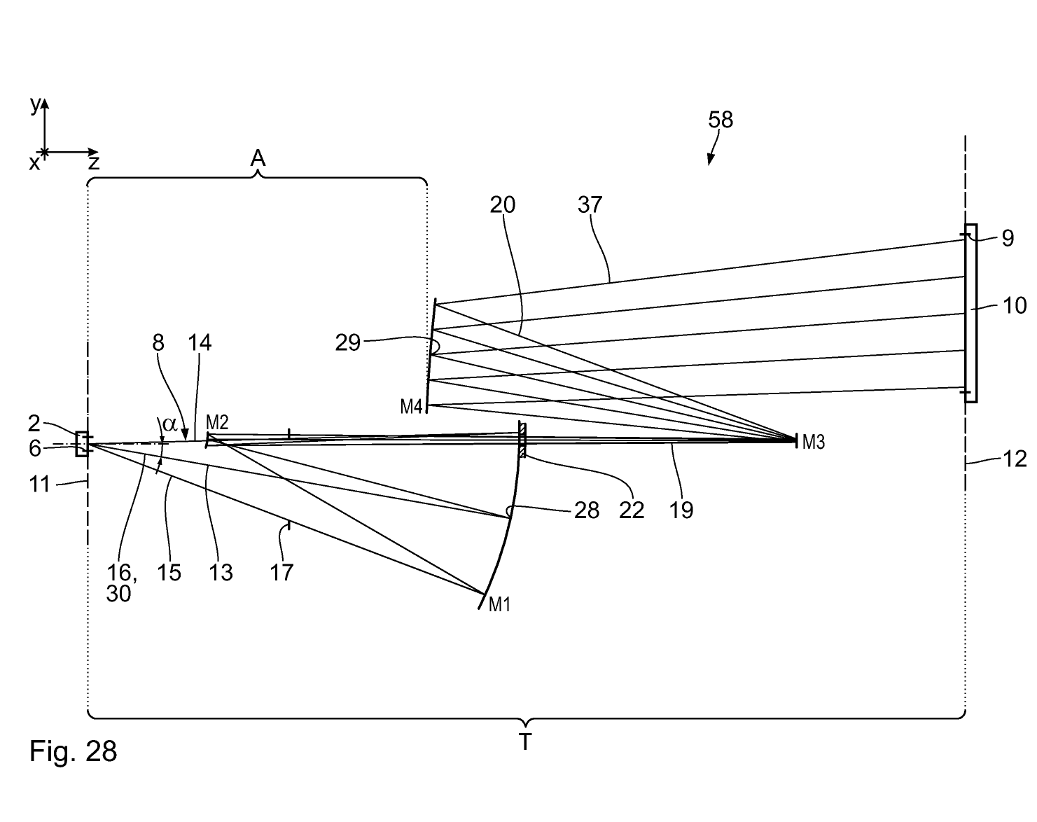

With reference to FIG. 28, a description is given below of a further embodiment of an imaging optical unit 58, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 58 has exactly four mirrors M1 to M4

The imaging partial ray 19 between the second mirror M2 and the third mirror M3 in the imaging beam path 8 passes the passage opening 21 in the mirror body 22 of the first mirror M1 of imaging optical unit 58.

The imaging optical unit 58 has an object-side chief ray angle α between the normal 16 to the object plane 11 and the chief ray 13 of a central object field point of 10°. The imaging optical unit 58 can be used for the bright field illumination.

The imaging optical unit 58 has a structural length T of 1300 mm between the object plane 11 and the image plane 12.

A distance A between the mirror M4 and the object plane 11 is more than 38% of the structural length T. In case of the imaging optical unit 58, enough structural space for the imaging optical unit 5 is present in the vicinity of the object plane 11.

The chief rays 13 of different field points run divergently in the imaging beam path 8 between the last mirror M3 and the image field 9.

The ratio T/β of the structural length T and the imaging scale β (β=711) is T/β=1.82 in the case of the imaging optical unit 58.

The imaging optical unit 58 has an object-side numerical aperture of 0.2. The object field 6 of the imaging optical unit 58 has a size of 306 μm in the y-direction and 408 μm in the x-direction.

An impingement point 28 of the chief ray 13 of the central object field point on the first mirror M1 in the imaging beam path 8 and an impingement point 29 of the chief ray 13 of central object field point on the fourth mirror M4 in the imaging beam path 8 lie on different sides of the plane 30.

The optical data of imaging optical unit 58 according to FIG. 28 are reproduced below with the aid of two tables which correspond in terms of structures to the tables of the imaging optical unit 7 according to FIG. 3.

| Surface | Radius | Thickness | Mode |
|---|---|---|---|
| Object | INFINITY | 296.323 | |
| STOP | INFINITY | 341.744 | |
| Mirror 1 | −516.195 | −463.010 | REFL |
| Mirror 2 | 57.307 | 872.873 | REFL |
| Mirror 3 | 50.000 | −547.930 | REFL |
| Mirror 4 | 1797.024 | 800.000 | REFL |
| Image | INFINITY | 0.000 | |

| Surface | K | A | B | C |
|---|---|---|---|---|
| Mirror 1 | −6,598742E−02 | −1.552137E−11 | −5.121132E−17 | −2.187397E−22 |
| Mirror 2 | 0.000000E+00 | −6.282086E−08 | 2.256927E−11 | −1.094029E−13 |
| Mirror 3 | 0.000000E+00 | 2.308663E−07 | −4.401882E−09 | 9.024446E−11 |
| Mirror 4 | 0.000000E+00 | 3.558040E−11 | −7.077130E−16 | 2.458008E−20 |
| Surface | D | E | F | G |
| Mirror 1 | 4.055956E−28 | −1.134847E−32 | 2.873614E−38 | 0.000000E+00 |
| Mirror 2 | 5.557270E−16 | −1.324566E−18 | 1.289002E−21 | 0.000000E+00 |
| Mirror 3 | −1.006407E−12 | 5.908172E−15 | −1.421500E−17 | 0.000000E+00 |
| Mirror 4 | −5.030491E−25 | 5.389670E−30 | −2.349207E−35 | 0.000000E+00 |

In case of the imaging optical unit 58, all mirrors M1 to M4 are embodied as aspherical mirrors. The image field 9 is planar.

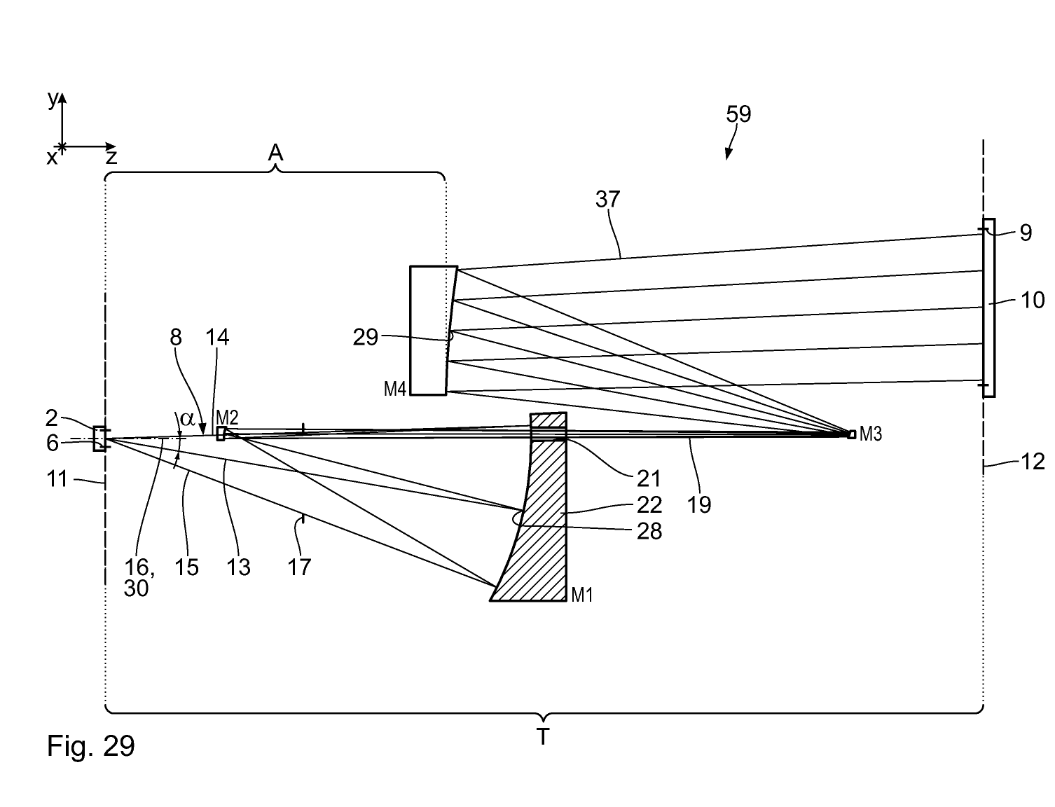

With reference to FIG. 29, a description is given below of a further embodiment of an imaging optical unit 59, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 59 corresponds to the imaging optical unit 58 of FIG. 28.

A difference is that mirror M4 of imaging optical unit 59 is spherical.

The optical data of imaging optical unit 59 according to FIG. 29 are reproduced below with the aid of two tables which correspond in terms of structures to the tables of the imaging optical unit 7 according to FIG. 3.

| Surface | Radius | Thickness | Mode |
|---|---|---|---|
| Object | INFINITY | 292.634 | |
| STOP | INFINITY | 337.366 | |
| Mirror 1 | −508.391 | −455.012 | REFL |
| Mirror 2 | 56.050 | 925.011 | REFL |
| Mirror 3 | 48.906 | −600.000 | REFL |
| Mirror 4 | 1554.806 | 800.000 | REFL |
| Image | INFINITY | 0.000 | |

| Surface | K | A | B | C |
|---|---|---|---|---|
| Mirror 1 | 0.000000E+00 | 4.715547E−11 | 1.809879E−16 | 6.262806E−22 |
| Mirror 2 | 0.000000E+00 | −7.323815E−08 | 1.341416E−11 | −2.837041E−14 |
| Mirror 3 | 0.000000E+00 | 9.968913E−08 | −3.661928E−10 | 6.824245E−12 |
| Surface | D | E | F | G |
| Mirror 1 | 2.511566E−27 | 5.772735E−33 | 4.915167E−38 | 0.000000E+00 |
| Mirror 2 | 1.263719E−16 | −1.541552E−19 | 1.900983E−23 | 0.000000E+00 |
| Mirror 3 | −4.729789E−14 | 1.253633E−16 | 6.159083E−24 | 0.000000E+00 |

In case of the imaging optical unit 59, the mirrors M1 to M3 are embodied as aspherical mirrors. The image field 9 is planar.

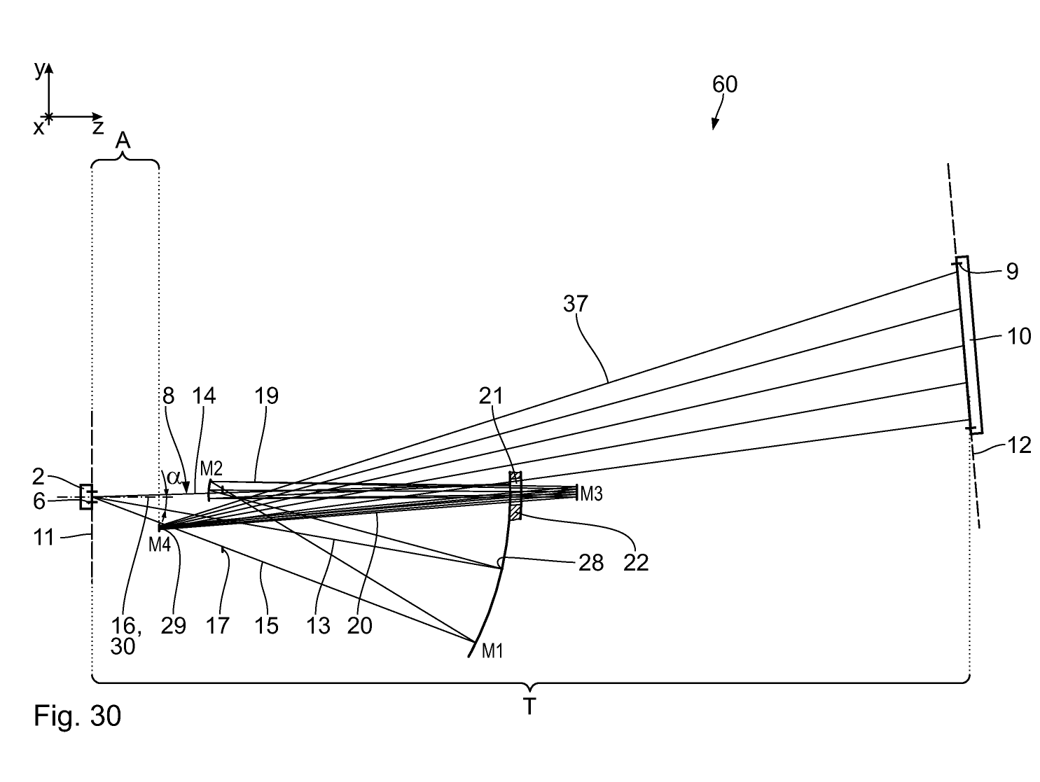

With reference to FIG. 30, a description is given below of a further embodiment of an imaging optical unit 60, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 60 has an object-side chief ray angle α between the normal 16 to the object plane 11 and the chief ray 13 of a central object field point of 10°. The imaging optical unit 60 can be used for the bright field illumination.

The imaging optical unit 60 has a structural length T of 1300 mm between the object plane 11 and the image field 9. The image plane 12 does not run parallel to the object plane 11.

The imaging partial ray 19 between the mirror M2 and the mirror M3, the imaging partial ray 20 between the mirror M3 and the mirror M4 and the imaging partial ray 37 between the last mirror M4 in the imaging beam path 8 of the imaging optical unit 60 all pass mirror M1 at a small distance. Dependent on the practical design of the mirror M1, this mirror M1 in a first embodiment has a passage opening 21 for passage of the imaging partial ray 19 between the second mirror M2 and the third mirror M3 in the imaging beam path and for passage of the imaging partial ray 20 between the third mirror M3 and the fourth mirror M4 in the imaging beam path. Such passage may be realized in the mirror M1 as a through-hole or as an edge side recess.

The chief rays 13 of different field points run divergently in the imaging beam path 8 between the last mirror M4 and the image field 9.

The ratio T/β of the structural length T and the imaging scale β (β=711) is T/β=1.82 in the case of the imaging optical unit 60.

The imaging optical unit 60 has an object-side numerical aperture of 0.2. The object field 6 of the imaging optical unit 60 has a size of 306 μm in the y-direction and 408 μm in the x-direction.

An impingement point 28 of the chief ray 13 of the central object field point on the first mirror M1 in the imaging beam path 8 and an impingement point 29 of the chief ray 13 of the central object field point on the fourth mirror M4 in the imaging beam path 8 lie on the same side of the plane 30.

Mirror M3 is planar with very low aspherical contributions.

Mirror M4 has a small diameter as compared to the other mirrors M1 to M3. Mirror M1 has a large diameter as compared to mirrors M2 to M4.

The optical data of the imaging optical unit 60 according to FIG. 30 are reproduced below with the aid of three tables. The first two tables correspond in terms of structure to the tables of the imaging optical unit 7 according to FIG. 3.

The third table shows decenter parameters. The parameter YDE is the y-decenter with respect to the local coordinate system of the surface of the respective optical component or field. The parameter ADE gives the tilt angle with respect to the x axis of the local coordinate system of the surface of the respective optical component or field.

Decenter type BEN (decenter and bend) corresponds to the fact that a reference axis for description of the following surfaces also is reflected at the surface. Decenter type DAR (decencer and return) corresponds to the fact that only the surface to which this decentered type refers to is decentered. The reference axis for description of the following surfaces remains unchanged.

| Surface | Radius | Thickness | Mode |
|---|---|---|---|
| Object | INFINITY | 195.298 | |
| STOP | INFINITY | 429.199 | |
| Mirror 1 | −493.270 | −449.497 | REFL |
| Mirror 2 | 80.948 | 549.497 | REFL |
| Mirror 3 | 1184860.795 | −624.497 | REFL |
| Mirror 4 | −66.100 | 1216.483 | REFL |
| Image | INFINITY | 0.000 | |

| Surface | K | A | B | C |
|---|---|---|---|---|
| Mirror 1 | −5.816921E−02 | 0.000000E+00 | 6.914712E−18 | −2.714395E−23 |
| Mirror 2 | −3.078104E−01 | 0.000000E+00 | 4.693560E−12 | −3.807573E−15 |
| Mirror 3 | 0.000000E+00 | 1.789193E−08 | −1.531460E−12 | 1.582776E−14 |
| Mirror 4 | −3.415509E+00 | 0.000000E+00 | −8.702688E−11 | 3.212090E−12 |
| Surface | D | E | F | G |
| Mirror 1 | 1.391299E−27 | −1.360055E−32 | 6.343599E−38 | 0.000000E+00 |
| Mirror 2 | 9.844683E−18 | −1.065946E−20 | 4.610258E−24 | 0.000000E+00 |
| Mirror 3 | −6.110633E−17 | 1.318972E−19 | −1.165050E−22 | 0.000000E+00 |
| Mirror 4 | −5.775782E−14 | 4.505083E−16 | −1.268868E−18 | 0.000000E+00 |

| | | | Decenter |
|---|---|---|---|
| | YDE | ADE | type |
| Mirror 3 | 0.026622 | 2.337361 | BEN |
| Mirror 4 | −0.029607 | 0.001951 | BEN |
| Image | 177.886707 | 0.010589 | DAR |

In the case of the imaging optical unit 60, mirrors M1 to M4 are embodied as aspherical mirrors. The image field 9 is planar. Mirrors M3, M4 and also the image field are decentered and tilted.

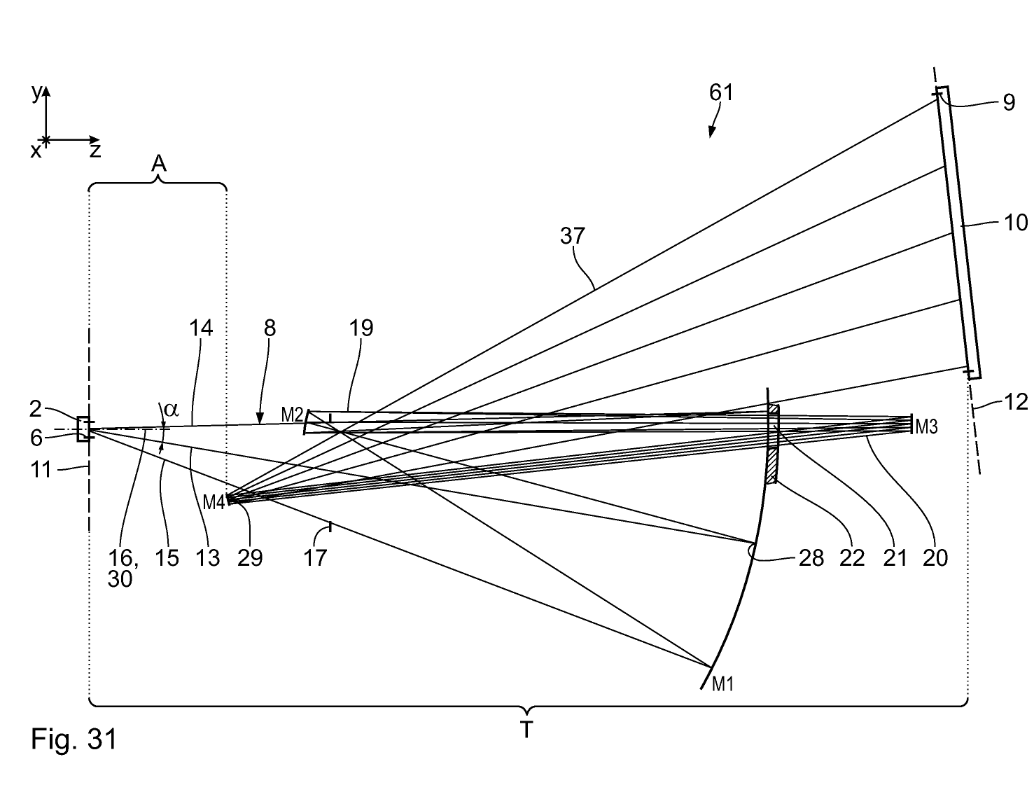

With reference to FIG. 31, a description is given below of a further embodiment of an imaging optical unit 61, which can be used instead of the imaging optical unit 7 according to FIG. 3. Components and functions corresponding to those which have already been explained in the previous figures bear the same reference numerals and will not be discussed in detail again. The differences relative to the previous exemplary embodiments are explained below.

The imaging optical unit 61 corresponds to the imaging optical unit 60 of FIG. 30.

The imaging optical unit 61 has a structural length T of 700 mm between the object plane 11 and the image field 9.

The ratio T/β of the structural length T and the imaging scale β (β=711) is T/β=0.98 in the case of the imaging optical unit 61.

The imaging optical unit 61 has an object-side numerical aperture of 0.2. The object field 6 of the imaging optical unit 61 has a size of 306 μm in the y-direction and 408 μm in the x-direction.

The optical data of the imaging optical unit 61 according to FIG. 31 are reproduced below with the aid of three tables. The first two tables correspond in terms of structure to the tables of the imaging optical unit 7 according to FIG. 3. The third table corresponds in terms of structure to the third table of the imaging optical unit 60 according to FIG. 30.

| Surface | Radius | Thickness | Mode |
|---|---|---|---|
| Object | INFINITY | 194.932 | |
| STOP | INFINITY | 355.769 | |
| Mirror 1 | −426.179 | −375.701 | REFL |
| Mirror 2 | 54.782 | 492.420 | REFL |
| Mirror 3 | 79033.237 | −557.420 | REFL |
| Mirror 4 | −42.790 | 607.420 | REFL |
| Image | INFINITY | 0.000 | |
| Surface | K | A | B |
| Mirror 1 | −6.271971E−02 | 0.000000E+00 | 9.222134E−18 |
| Mirror 2 | −3.208834E−01 | 0.000000E+00 | 2.697892E−11 |
| Mirror 3 | 0.000000E+00 | 3.311824E−08 | −7.463884E−13 |
| Mirror 4 | −3.327639E+00 | 0.000000E+00 | −2.733498E−10 |
| Surface | C | D | E |
| Mirror 1 | 2.805504E−23 | 9.373245E−28 | −1.916234E−33 |
| Mirror 2 | −7.789744E−15 | 5.690974E−17 | −6.321964E−20 |
| Mirror 3 | 1.269030E−14 | −8.891973E−18 | −3.128143E−20 |
| Mirror 4 | −2.183069E−12 | 1.620091E−14 | −3.049564E−17 |
| | | | Decenter |
| | YDE | ADE | type |
| Mirror 3 | 0.064273 | 3.176114 | BEN |
| Mirror 4 | −0.008075 | −0.001267 | BEN |
| Image | 154.764702 | 0.011999 | DAR |

In the case of the imaging optical unit 61, mirrors M1 to M4 are embodied as aspherical mirrors. Mirror M2 again practically is planar, having very low aspherically constributions. The image field 9 is planar. Mirrors M3, M4 and also the image field are decentered and tilted.

Some characteristic variables of the imaging optical unit are summarized in the tables below, namely the object-side numerical aperture NAO, the field size, that is to say the size of the object field 6, the magnification scale β, the structural length T, a wavefront aberration (rms) in units of the used wavelength λ and a maximum distortion, indicated in μm, and also the object-side chief ray angle α of the central object field point.

| | Imaging | Imaging | Imaging | Imaging | Imaging |
|---|---|---|---|---|---|
| | optical unit | optical unit | optical unit | optical unit | optical unit |
| | 7 | 27 | 32 | 34 | 39 |
| NAO | 0.25 | 0.24 | 0.24 | 0.24 | 0.24 |
| Field size y times x | 40 × 200 | 100 × 300 | 100 × 400 | 100 × 300 | 100 × 200 |
| [μm × μm] | | | | | |
| Scale β | 750 | 850 | 850 | 850 | 850 |
| Structural length T [mm] | 878 | 800 | 741 | 1227 | 800 |
| Wavefront (rms) [λ] | 0.031 | 0.013 | 0.022 | 0.002 | 0.006 |
| Distortion (max) [μm] | 0.4 | 0.3 | 1.5 | 0.04 | 0.15 |
| Object-side chief ray | 0° | 10° | 10° | 10° | 10° |
| angle α | | | | | |
| T/β | 1.17 | 0.94 | 0.87 | 1.44 | 0.94 |
| | Imaging | Imaging | Imaging | Imaging | Imaging |
| | optical unit | optical unit | optical unit | optical unit | optical unit |
| | 41 | 43 | 45 | 47 | 49 |
| NAO | 0.24 | 0.24 | 0.24 | 0.24 | 0.25 |
| Field size y times x | 100 × 400 | 100 × 400 | 100 × 400 | 100 × 400 | 106 × 680 |
| [μm × μm] | | | | | |
| Scale β | 850 | 850 | −850 | −850 | 850 |
| Structural length T [mm] | 791 | 786 | 1050 | 800 | 1088 |
| Wavefront (rms) [λ] | 0.011 | 0.007 | 0.465 | 0.216 | 0.014 |
| Distortion (max) [μm] | 0.25 | 0.32 | 62.8 | 12.3 | 7.2 |
| Object-side chief ray | 10° | 10° | 10° | 10° | 0° |
| angle α | | | | | |
| T/β | 0.93 | 0.92 | 1.24 | 0.94 | 1.28 |
| | Imaging | Imaging | Imaging | Imaging | Imaging |
| | optical unit | optical unit | optical unit | optical unit | optical unit |
| | 50 | 51 | 53 | 55 | 56 |
| NAO | 0.24 | 0.24 | 0.24 | 0.2 | 0.125 |
| Field size y times x | 106 × 680 | 212 × 340 | 212 × 340 | 306 × 408 | 490 × 652 |
| [μm × μm] | | | | | |
| Scale β | 850 | 850 | 850 | 711 | 444 |
| Structural length T [mm] | 1000 | 1010 | 1093 | 1439 | 1300 |
| Wavefront (rms) [λ] | 0.008 | 0.004 | 0.065 | 0.0091 | 0.0108 |
| Distortion (max) [μm] | 0.3 | 0.1 | 9.7 | 0.7 | 0.4 |
| Object-side chief ray | 0° | 0° | 0° | 10° | 6° |
| angle α | | | | | |
| T/β | 1.18 | 1.19 | 1.29 | 2.02 | 2.93 |
| | Imaging | Imaging | Imaging | Imaging | Imaging |
| | optical unit | optical unit | optical unit | optical unit | optical unit |
| | 57 | 58 | 59 | 60 | 61 |
| NAO | 0.2 | 0.2 | 0.2 | 0.2 | 0.2 |
| Field size y times x | 306 × 408 | 306 × 408 | 306 × 408 | 306 × 408 | 306 × 408 |
| [μm × μm] | | | | | |
| Scale β | 711 | 711 | 711 | 711 | 711 |
| Structural length T [mm] | 1068 | 1300 | 1300 | 700 | 700 |
| Wavefront (rms) [λ] | 0.011 | 0.011 | 0.2012 | 0.022 | 0.022 |
| Distortion (max) [μm] | 0.7 | 0.8 | 1.1 | 4.2 | 4.2 |
| Object-side chief ray | 10° | 10° | 10° | 10° | 10° |
| angle α | | | | | |
| T/β | 1.50 | 1.82 | 1.82 | 1.82 | 0.98 |

1.-15. (canceled)

16. An imaging optical unit, comprising:
at most four mirrors configured so that during use of the imaging optical unit:
the at least four mirrors image an object field in an object plane into an image field in an image plane via an imaging beam path comprising imaging partial rays between mirrors that are adjacent in the imaging beam path;
a first imaging partial ray is between a second mirror in the imaging beam path and a third mirror in the imaging beam path;
the first partial imaging ray passes through a first passage opening in a mirror body of a first mirror in the imaging beam path;
a second imaging partial ray is after the third mirror in the imaging beam path; and
the second partial imaging ray passes through a second passage opening in a mirror body of the first mirror in the imaging beam path,
wherein the imaging optical unit is a magnifying imaging optical unit.

17. The imaging optical unit of claim 16, wherein the first and second passage openings are the same passage opening.

18. The imaging optical unit of claim 17, wherein the optical imaging unit is configured so that, during use of the optical imaging unit:
a third imaging partial ray is between the fourth mirror in the imaging beam path and the image field; and
the third imaging partial ray passes through the mirror body of the first mirror in the imaging beam path.

19. The imaging optical unit of claim 16, wherein the optical imaging unit is configured so that, during use of the optical imaging unit:
a third imaging partial ray is between the fourth mirror in the imaging beam path and the image field; and
the third imaging partial ray passes through the mirror body of the first mirror in the imaging beam path.

20. The imaging optical unit of claim 19, wherein, during use of the imaging optical unit, the passage opening is shaded by one of the mirrors at least in sections in the imaging beam path.

21. The imaging optical unit of claim 18, wherein, during use of the imaging optical unit, the passage opening is shaded by one of the mirrors at least in sections in the imaging beam path.

22. The imaging optical unit of claim 17, wherein, during use of the imaging optical unit, the passage opening is shaded by one of the mirrors at least in sections in the imaging beam path.

23. The imaging optical unit of claim 16, wherein, during use of the imaging optical unit, the passage opening is shaded by one of the mirrors at least in sections in the imaging beam path.

24. The imaging optical unit of claim 16, wherein, during use of the imaging optical unit, the imaging optical unit has an object-side numerical aperture of at least 0.2.

25. The imaging optical unit of claim 16, wherein, during use of the imaging optical unit, the object field has a size of at least 40 μm×200 μm.

26. The imaging optical unit of claim 16, wherein, during use of the imaging optical unit, the imaging optical unit has an RMS wavefront aberration of at most 500 mλ.

27. The imaging optical unit of claim 16, wherein, during use of the imaging optical unit, the imaging optical unit has a distortion of at most 63 μm.

28. The imaging optical unit of claim 16, wherein during use of the imaging optical unit:
an object-side chief ray angle between a normal to the object plane and a chief ray of a central object field point that is less than 1°; or
an object-side chief ray angle between a normal to the object plane and a chief ray of a central object field point is at least 6°.

29. The imaging optical unit of claim 28, wherein, during use of the optical imaging unit, an impingement point of the chief ray of the central object field point on the first mirror in the imaging beam path and an impingement point of the chief ray of the central object field point on the fourth mirror in the imaging beam path lie on different sides of a plane which is perpendicular to a meridional plane of the imaging optical unit and in which the normal to the object plane lies.

30. The imaging optical unit of claim 28, wherein, during use of the optical imaging unit, an impingement point of the chief ray of the central object field point on the first mirror in the imaging beam path and an impingement point of the chief ray of the central object field point on the fourth mirror in the imaging beam path lie on the same side of a plane which is perpendicular to a meridional plane of the imaging optical unit and in which the normal to the object plane lies.

31. The imaging optical unit of claim 16, further comprising an aperture stop, wherein, during use of the imaging optical system, at least two imaging partial rays pass through the aperture stop.

32. The imaging optical unit of claim 16, wherein, during use of the imaging optical unit, at least two intermediate images are present in the imaging beam path between the object field and the image field.

33. A system, comprising:
an imaging optical unit according to claim 16;
a light source configured to illuminate the object field; and
a spatially resolving detection device that detects the image field,
wherein the system is configured to examine objects.

34. A method of using a system comprising an imaging optical unit, a light source and a spatially resolving detection device, the method comprising:
using the light source to illuminate an object field of the imaging optical unit; and
using the spatially resolving detection device to detect an image field of the imaging optical unit,
wherein the imaging optical unit is an imaging optical unit according to claim 16.

35. An imaging optical unit, comprising:
at most four mirrors configured so that, during use of the imaging optical unit, the at least four mirrors image an object field in an object plane into an image field in an image plane via an imaging beam path,
wherein the imaging optical unit:
has a structural length that is at most 1300 mm;
has an imaging scale;
has a ratio of the structural length and the imaging scale that is less than 1.5 mm;
has an object-side chief ray angle between a normal to the object plane and a chief ray of a central object field point which is at least 6°; and
is a magnifying imaging optical unit.
